(19) United States
(12) Patent Application Publication
(10) Pub. No.: US 2026/0361714 A1
(43) Pub. Date: Nov. 12, 2026

(54) PRESENTATION ATTACK DETECTION USING AGGREGATED SAMPLE ANALYSIS

(71) Applicant: KEYLESS TECHNOLOGIES LIMITED, London (GB)

(72) Inventors: Lukas Vrabel, Brno (CZ); Zdenka Sedenka, Brno (CZ); William Marques Dias, Campinas (BR); Luca Baronti, Bournemouth (GB); Davide Orru, Oristano (IT); Giovanni Ciampi, Zurich (CH); Emanuela Piciucco, Lisbon (PT); Pierluigi Failla, Grosseto (IT); Jaroslav Sedenka, Hranice (CZ); Paolo Gasti, New York, NY (US)

(73) Assignee: KEYLESS TECHNOLOGIES LIMITED, London (GB)

(21) Appl. No.: 18/990,541

(22) Filed: Dec. 20, 2024

Related U.S. Application Data
(60) Provisional application No. 63/680,756, filed on Aug. 8, 2024.

(51) Int. Cl. H04L 9/40

(52) U.S. Cl. CPC H04L 63/0861; H04L 63/1416

(57) ABSTRACT

Systems, methods, and computer-readable media for detecting presentation attack are provided.

### CROSS-REFERENCE TO RELATED APPLICATION(S)

This application claims the benefit of prior filed U.S. Provisional Patent Application No. 63/680,756, filed Aug. 8, 2024, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to biometric authentication systems and methods, and, more particularly, to systems and methods for detecting presentation attack.

### BACKGROUND OF THE DISCLOSURE

Biometric authentication systems have become increasingly popular as a secure and convenient tool for verifying an individual's identity. However, the security of these systems can be impacted if an attacker can successfully use a fake or artificial representation of the individual's biometric features. To address this issue, presentation attack detection techniques may be developed to distinguish between authentic live biometric data and recorded or simulated data.

### SUMMARY OF THE DISCLOSURE

This document describes systems, methods, and computer-readable media for detecting a presentation attack.

For example, a method for detecting presentation attack is provided.

As another example, a system for detecting presentation attack is provided.

As yet another example, a non-transitory computer-readable storage medium storing at least one program, the at least one program including instructions, which, when executed by at least one processor of an electronic subsystem, cause the at least one processor to detect presentation attack is provided.

As yet another example, a method is provided for managing an authentication processing service (“APS”) system using a model custodian system, including initially configuring, at the model custodian system, a learning engine for the APS system, receiving, at the model custodian system from the APS system, monitored system data for at least one monitored system data category for an APS experience and an APS output state for the APS experience, training, at the model custodian system, the learning engine using the received monitored system data and the received APS output state, accessing, at the model custodian system, monitored system data for the at least one monitored system data category for another APS experience, determining an APS output state for the other APS experience, using the learning engine for the APS system at the model custodian system, with the accessed monitored system data for the other APS experience, and, when the determined APS output state for the other APS experience satisfies a condition, generating, with the model custodian system, control data associated with the satisfied condition, wherein the other APS experience is a biometric authentication session, and wherein the APS output state for the other APS experience is indicative of a likelihood of a presentation attack during the biometric authentication session.

As yet another example, a model custodian system is provided that may include a communications component and a processor operative to initially configure a learning engine for an authentication processing service (“APS”) system, receive, from the APS system, monitored system data for at least one monitored system data category for an APS experience and an APS output state for the APS experience, train the learning engine using the received monitored system data and the received APS output state, access monitored system data for the at least one monitored system data category for another APS experience, determine an APS output state for the other APS experience, using the learning engine for the APS system, with the accessed monitored system data for the other APS experience, and when the determined APS output state for the other APS experience satisfies a condition, generate control data associated with the satisfied condition, wherein the other APS experience is a biometric authentication session, and wherein the APS output state for the other APS experience is indicative of a likelihood of a presentation attack during the biometric authentication session.

As yet another example, a non-transitory computer-readable storage medium is provided that may store at least one program, the at least one program including instructions, which, when executed by at least one processor of an electronic subsystem, cause the at least one processor to initially configure a learning engine for an authentication processing service (“APS”) system, receive, from the APS system, monitored system data for at least one monitored system data category for an APS experience and an APS output state for the APS experience, train the learning engine using the received monitored system data and the received APS output state, access monitored system data for the at least one monitored system data category for another APS experience, determine an APS output state for the other APS experience, using the learning engine for the APS system, with the accessed monitored system data for the other APS experience, and, when the determined APS output state for the other APS experience satisfies a condition, generate control data associated with the satisfied condition, wherein the other APS experience is a biometric authentication session, and wherein the APS output state for the other APS experience is indicative of a likelihood of a presentation attack during the biometric authentication session.

This Summary is provided to summarize some example embodiments, so as to provide a basic understanding of some aspects of the subject matter described in this document.

Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for providing an authentication processing service, according to one or more embodiments of the disclosure;

FIG. 1A is a more detailed schematic view of a subsystem of the system of FIG. 1, according to one or more embodiments of the disclosure;

FIG. 2 is a detailed schematic view of at least a portion of another illustrative system for providing an authentication processing service, according to one or more embodiments of the disclosure;

FIG. 3 is a detailed schematic view of at least a portion of another illustrative system for providing an authentication processing service, according to one or more embodiments of the disclosure;

FIGS. 4A-4I illustrate exemplary screens of graphical user interfaces (“UIs”) of one or more devices of a system for providing authentication processing services, according to one or more embodiments of the disclosure; and

FIG. 5 illustrates a flowchart of an exemplary process for providing an authentication processing service, according to one or more embodiments of the disclosure.

### DETAILED DESCRIPTION OF THE DISCLOSURE

The present disclosure relates generally to authentication processing service (e.g., biometric authentication) systems and methods and more particularly to systems and methods for detecting a presentation attack. The disclosure provides a new and improved approach to liveness and/or any other suitable authentic biometric authentication detection that can be used with various types of biometric and/or behaviormetric data, including, but not limited to, biometric/behaviormetric data of an individual's face, fingerprint, iris, voice, gait, and/or the like, and has potential applications in various industries, including, but not limited to, finance, healthcare, border control, and the like.

The present disclosure provides a novel approach to presentation attack detection that may utilize multiple samples from a single biometric authentication session, that may optionally validate that each one of the multiple samples corresponds to the same individual's identity, and/or that may aggregate decisions from individual samples over time (e.g., a decision or prediction or estimate on the likelihood of whether or not an individual sample is a spoof or presentation attack (e.g., a statistical estimate converted by logic/policy modules to make a decision) may be aggregated over multiple samples over time) in order to achieve better presentation attack performance. This aggregation can be done, for example, using any suitable machine learning techniques. Such an innovative method may be configured to overcome limitations of single frame liveness detection techniques (e.g., single-frame systems may be less capable of performing motion estimation) in detecting whether a biometric sample is from a live individual or from an artificial representation of a live individual. Additionally, in some embodiments, a detector may be configured to process not only two or more image data frames but also any suitable fast data (e.g., environment data and/or motion data) that may be acquired in between two or more image data frames in order to make a determination about the likelihood of one or more presentation attacks. Therefore, a detector may be configured to compare and correlate continuous fast data readings to any changes between image data frames, thereby combining such two types of data to make better determinations.

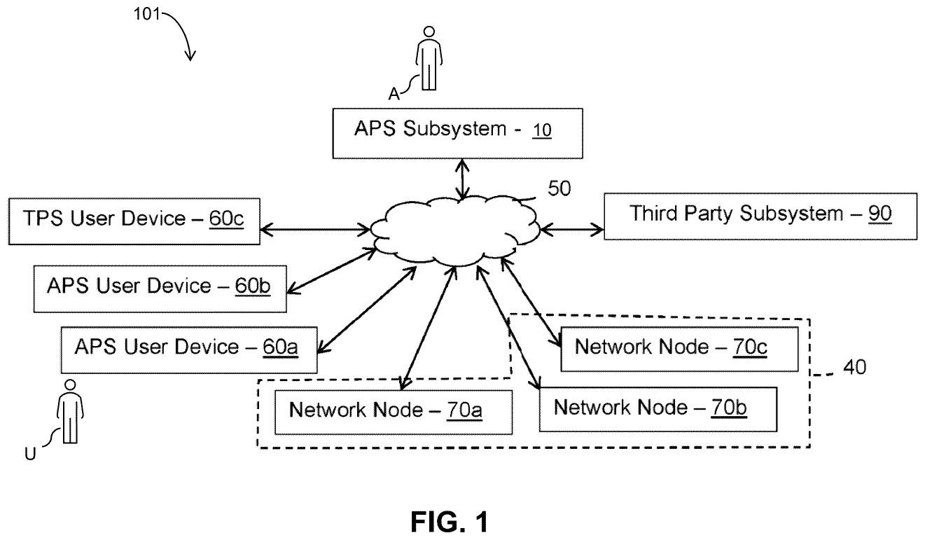

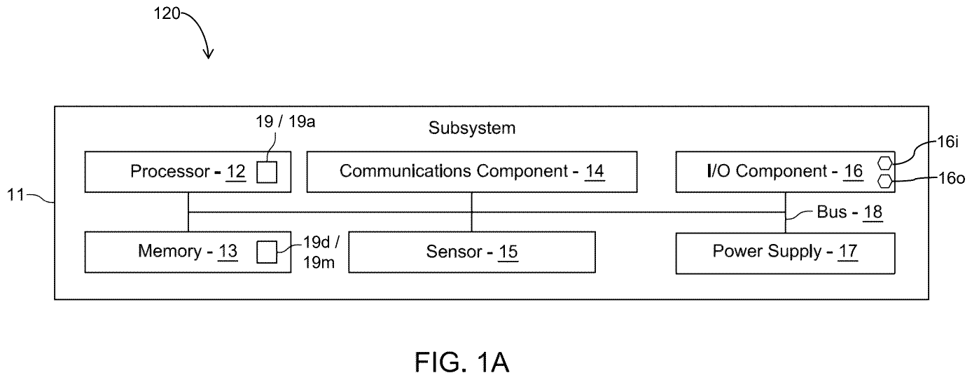

### FIGS. 1 and 1A

FIG. 1 is a schematic view of an illustrative system 101 in which authentication processing may be facilitated utilizing any suitable user device trusted user device and/or one or more network nodes. For example, as shown in FIG. 1, system 101 may include an authentication processing service (“APS”) subsystem 10, one or more user subsystems or devices 60 (e.g., one or more APS user subsystems or devices (e.g., APS user devices 60a and 60b) and/or one or more third party service (“TPS”) user subsystems or devices (e.g., TPS user device 60c)), one or more network subsystems or servers or nodes 70 (e.g., network nodes 70a-70c), at least one third party enabler subsystem 90, and at least one communications network 50 through which APS subsystem 10 and at least one user device 60 and/or at least one network node 70 and/or at least one third party enabler subsystem 90 may communicate. Some or all portions of APS subsystem 10 may be operated, managed, or otherwise at least partially controlled by any suitable entity (e.g., an administrator A (e.g., Keyless™ or any other suitable entity)) that may be responsible for providing to one or more other entities (e.g., a user U) of system 101 an authentication processing service or authentication processing service platform (“APSP”). In some embodiments, a node 70 may be provided by a user device 60 for use by another user (e.g., one user device 60 of system 101 may be configured to operate as a node 70 for another user device 60 of system 101). Nodes 70 of system 101 ought to be available and non-colluding. For example, an APSP network 40 (e.g., a decentralized and/or distributed network) of system 101 may include two or more nodes 70. In some embodiments, an APSP network 40 may include one or more user devices that may be at least partially configured as a node for one or more other user devices. Network 40 may be designed to scale to a geographically-distributed, large number of users. As a result, any suitable APSP protocol may be configured to adhere to one or more suitable design requirements, including, but not limited to, the capacity of the network (e.g., the number of users that the network can handle) ought to increase linearly with the number of nodes, if a number of the nodes fail, the network ought to still be operational for the vast majority of the users, and/or the like. In some embodiments, at any point in time a user device may be enrolled with or authenticating with a particular (e.g., fixed) subset of the nodes in the network. Adding new nodes may enable more users to effectively use the network. To reduce latency, the nodes can be strategically placed close to their users. Given the availability of geographically distributed data centers from major cloud providers, this may be a simple and cost-effective way to improve user experience and provide quality of service. For segregated networks (e.g., enterprise, etc.), nodes can be deployed within the perimeter of the segregated network. For air-gapped networks (e.g., military, intelligence, and disaster recovery networks, etc.), nodes can be deployed inside the air-gapped network.

As shown in FIG. 1A, a subsystem or system device 120 (e.g., one, some, or each of the devices and/or subsystems described herein of FIG. 1 (e.g., device 60a, device 60b, device 60c, node 70a, node 70b, node 70c, subsystem 10, subsystem 90, and/or otherwise) may include any suitable components or modules, including, but not limited to, a processor component 12, a memory component 13, a communications component 14, a sensor 15, an input/output (“I/O”) component 16, a power supply component 17, a housing 11, and/or a bus 18 that may provide one or more wired or wireless communication links or paths for transferring data and/or power to, from, or between various other components of subsystem 120. In some embodiments, one or more components of subsystem 120 may be combined or omitted. Moreover, subsystem 120 may include other components not combined or included in FIG. 1A and/or several instances of the components shown in FIG. 1A. For the sake of simplicity, only one of each of the components of subsystem 120 is shown in FIG. 1A.

I/O component 16 may include at least one input component 16i (e.g., a button, mouse, keyboard, etc.) to receive information from a user or other device or power therefrom and/or at least one output component 160 (e.g., an audio output component or speaker, video output component or display, haptic output component (e.g., rumbler, vibrator, etc.), lighting output component, olfactory output component, movement actuator, etc.) to provide information or power or any other suitable support to a user or other device, such as a touch screen I/O component that may receive input information through a user's touch of a display screen and that may also provide visual information to a user via that same display screen, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d (e.g., unique user identifier information, models, neural networks, algorithms, application data, etc.) and/or any suitable service system management model 19m (e.g., that may be used by any suitable application 19a))). Memory 13 may include suitable logic, circuitry, and/or code that may enable storage of various types of information, such as received data, generated data, code, and/or configuration information.

Communications component 14 may be provided to allow subsystem 120 to communicate with one or more other subsystems 120 (e.g., any communication to, from, and/or between subsystem(s) 10, 60, 90, and/or the like of system 101 (e.g., via any suitable network 50)) using any suitable communications protocol(s). Communications component 14 can be operative to create or connect to a communication network or link of a network. Communications component 14 can provide wireless communications using any suitable short-range or long-range communications protocol, such as Wi-Fi (e.g., an 802.11 protocol), ZigBee™ (e.g., an 802.15.4 protocol), WiDi™, Ethernet, Bluetooth™ Low Energy (“BLE”), ultra-wideband, radio frequency systems (e.g., 1200 MHz, 2.4 GHz, and 5.6 GHz communication systems), high frequency systems (e.g., 900 MHz, 2.4 GHz, and 5.6 GHz communication systems), near field communication (“NFC”), infrared, protocols used by wireless and cellular telephones and personal e-mail devices, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access. Communications component 14 may also include or may be electrically coupled to any suitable transceiver circuitry that can enable subsystem 120 to be communicatively coupled to another subsystem and communicate data with that other device wirelessly or via a wired connection (e.g., using a connector port). Communications component 14 (and/or sensor assembly 15) may be configured to determine a geographical position of subsystem 120 and/or any suitable data that may be associated with that position. For example, communications component 14 may utilize a global positioning system (“GPS”) or a regional or site-wide positioning system that may use cell tower positioning technology or Wi-Fi™ technology, or any suitable location-based service or real-time locating system, which may use a geo-fence for providing any suitable location-based data to subsystem 120 (e.g., to determine a current geo-location of subsystem 120 and/or any other suitable associated data. Communications component 14 may include or otherwise provide a network interface that may include mechanical, electrical, and/or signaling circuitry for communicating any suitable data over any suitable physical links that may be coupled to network 50.

Sensor 15 may be any suitable sensor that may be configured to sense any suitable data for subsystem 120 (e.g., location-based data via a global positioning system (“GPS”) sensor system or any other suitable location determination protocol, motion data, environmental data, biometric data, etc.). Sensor 15 may be a sensor assembly that may include any suitable sensor or any suitable combination of sensors operative to detect movements of subsystem 120 and/or of any user thereof and/or any other characteristics of subsystem 120 and/or of its environment (e.g., physical activity or other characteristics of a user of subsystem 120, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of subsystem 120 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z-or forward/backward direction). As another example, sensor 15 may include one or more single-axis or two-axis acceleration motion sensors that may be operative to detect linear acceleration only along each of the x-or left/right direction and the y-or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement (e.g., any suitable inertial measurement unit (“IMU”), such as a gyroscope and/or an accelerometer and/or a magnetometer sensor (e.g., a Gauss meter, a magnetic measurement unit (“MMU”), an inertial MMU (“IMMU”), etc.). For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on subsystem 120, such as any suitable pressure sensors, altimeters, or the like. Using sensor 15, subsystem 120 may be configured to determine a velocity, acceleration, orientation, and/or any other suitable motion attribute of subsystem 120. Sensor 15 may include any suitable sensor components or subassemblies for detecting any suitable biometric data and/or health data and/or sleep data and/or mindfulness data and/or the like of a user of subsystem 120. For example, sensor 15 may include any suitable biometric sensor and/or behaviormetric sensor that may include, but is not limited to, one or more facial recognition sensors, fingerprint scanners, iris scanners, retinal scanners, voice recognition sensors, gait sensors, hair sensors, hand geometry sensors, signature scanners, keystroke dynamics sensors, vein matching sensors, heart beat sensors, body temperature sensors, odor or scent sensors, behavioral biometric sensors (e.g., user behavioral modeling of movement, orientation, gesture, pausality, etc.), DNA sensors, sensors for any unclonable or extremely difficult to replicate personal function, and/or any other suitable sensors for detecting any suitable metrics related to any suitable characteristics of a user, which may also include health related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. These sensors can generate data providing health related information associated with the user. For example, PPG sensors can provide information regarding a user's respiratory rate, blood pressure, and/or oxygen saturation. ECG sensors can provide information regarding a user's heartbeats. GSR sensors can provide information regarding a user's skin moisture, which may be indicative of sweating and can prioritize a thermostat application to determine a user's body temperature. One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 120 for attempting to authenticate a user), line-in connector for data and/or power, and/or combinations thereof. In some examples, each sensor can be a separate device, while, in other examples, any combination of two or more of the sensors can be included within a single device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single device. Using one or more of these sensors, subsystem 120 can determine physiological characteristics of the user while performing a detected activity, such as a heart rate of a user associated with the detected activity, average body temperature of a user detected during the detected activity, any normal or abnormal physical conditions associated with the detected activity, or the like. In some examples, a GPS sensor or any other suitable location detection component(s) of subsystem 120 can be used to determine a user's location (e.g., geo location and/or address and/or location type (e.g., library, school, office, zoo, etc.)) and movement, as well as a displacement of the user's motion. An accelerometer, directional sensor, and/or gyroscope can further generate activity data that can be used to determine whether a user of subsystem 120 is engaging in an activity, is inactive, or is performing a gesture. Any suitable activity of a user may be tracked by sensor 15, including, but not limited to, steps taken, flights of stairs climbed, calories burned, distance walked, distance run, minutes of exercise performed and exercise quality, time of sleep and sleep quality, nutritional intake (e.g., foods ingested and their nutritional value), mindfulness activities and quantity and quality thereof (e.g., reading efficiency, data retention efficiency), any suitable work accomplishments of any suitable type (e.g., as may be sensed or logged by user input information indicative of such accomplishments), and/or the like. Subsystem 120 can further include a timer that can be used, for example, to add time dimensions to various attributes of any detected element(s) (e.g., the detected physical activity, such as a duration of a user's physical activity or inactivity, time(s) of a day when the activity is detected or not detected, and/or the like). Sensor 15 may include any suitable sensor components or subassemblies for detecting any suitable characteristics of any suitable condition of the lighting of the environment of subsystem 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 120 (e.g., in lux or lumens per square meter, etc.) and/or for determining the ambient color or white point chromaticity of ambient light in the environment of subsystem 120 (e.g., in hue and colorfulness or in x/y parameters with respect to an x-y chromaticity space, etc.) and/or for determining the UV index or UV radiation in the environment of subsystem 120 (e.g., in UV index units, etc.). A suitable light sensor may include, for example, a photodiode, a phototransistor, an integrated photodiode and amplifier, or any other suitable photo sensitive device. In some embodiments, more than one light sensor may be integrated into subsystem 120. Sensor 15 may include any suitable sensor components or subassemblies for detecting any suitable characteristics of any suitable condition of the air quality of the environment of subsystem 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 120 (e.g., in O₂ % per liter, etc.) and/or for determining the air velocity of the ambient air in the environment of subsystem 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 120 (e.g., in HG % per liter, etc.) and/or for determining the humidity of the ambient air in the environment of device 120 (e.g., in grams of water per cubic meter, etc. (e.g., using a hygrometer)) and/or for determining the temperature of the ambient air in the environment of subsystem 120 (e.g., in degrees Celsius, etc. (e.g., using a thermometer)). Sensor 15 may include any suitable sensor components or subassemblies for detecting any suitable characteristics of any suitable condition of the sound quality of the environment of subsystem 120. For example, sensor 15 may include any suitable sound quality sensor that may include, but is not limited to, one or more microphones or the like that may determine the level of sound pollution or noise in the environment of subsystem 120 (e.g., in decibels, etc.). Sensor 15 may also include any other suitable sensor for determining any other suitable characteristics about a user of subsystem 120 and/or the environment of subsystem 120 and/or any situation within which subsystem 120 may be existing. For example, any suitable clock and/or position sensor(s) may be provided to determine the current time and/or time zone within which subsystem 120 may be located.

Sensor 15 may be embedded in a body (e.g., housing 11) of subsystem 120, such as along a bottom surface that may be operative to contact a user, or can be positioned at any other desirable location. In some examples, different sensors can be placed in different locations inside or on the surfaces of subsystem 120 (e.g., some located inside housing 11 and some attached to an attachment mechanism (e.g., a wrist band coupled to a housing of a wearable device), or the like). In other examples, one or more sensors can be worn by a user separately as different parts of a single subsystem 120 or as different devices. In such cases, the sensors can be configured to communicate with subsystem 120 using a wired and/or wireless technology (e.g., via communications component 14). In some examples, sensors can be configured to communicate with each other and/or share data collected from one or more sensors. In some examples, subsystem 120 can be waterproof such that the sensors can detect a user's activity in water.

Power supply 17 can include any suitable circuitry for receiving and/or generating power, and for providing such power to one or more of the other components of subsystem 120. For example, power supply assembly 17 can be coupled to a power grid (e.g., when subsystem 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 120 is acting as a portable device). Subsystem 120 may also be provided with a housing 11 that may at least partially enclose one or more of the components of subsystem 120 for protection from debris and other degrading forces external to subsystem 120. Each component of subsystem 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem 90 and/or by APS subsystem 10 for enabling user device 60 to interact with an online service), application programming interfaces (“APIs”), software development kits (“SDKs”), APS applications (e.g., a web application or a native application that may be at least partially produced by APS subsystem 10 for enabling user device 60 to interact with an online service and/or one or more network nodes 70 and/or a third party subsystem 90), any other suitable applications, and/or the like. For example, processor 12 may load an application 19 as an interface program to determine how instructions or data received via an input component 16i of I/O component 16 or other component of subsystem 120 (e.g., sensor 15 and/or communications component 14) may manipulate the way in which information may be stored (e.g., in memory 13) and/or provided to via an output component 160 of I/O component 16 and/or to another system device via communications component 14. As one example, application 19 may be a third party application that may be running on subsystem 120 that may be loaded on subsystem 120 (e.g., using communications component 14) via an application market, such as the Apple App Store or Google Play, or that may be accessed via an internet application or web browser (e.g., by Apple Safari or Google Chrome) that may be running on subsystem 120 and that may be pointed to a uniform resource locator (“URL”) whose target or web resource may be managed by or otherwise affiliated with any suitable entity. Any device (e.g., any user device or subsystem or server) may include any suitable special purpose hardware (e.g., hardware support of high-speed packet processing, hardware support of machine learning algorithms, etc.). Processor 12 may include suitable logic, circuitry, and/or code that may enable processing data and/or controlling operations of subsystem 120. In this regard, processor 12 may be enabled to provide control signals to various other components of subsystem 120. Processor 12 may also control transfers of data between various portions of subsystem 120. Processor 12 may further implement an operating system or may otherwise execute code to manage operations of subsystem 120. As one example, application 19 may provide a user with the ability to interact with an authentication processing service platform (“APSP”) of system 101, where application 19 may be a third party application that may be running on user device 60 (e.g., an application associated with APS subsystem 10 and/or third party subsystem 90) that may be loaded on user device 60 (e.g., using communications component 14) via an application market, such as the Apple App Store or Google Play, or that may be accessed via an internet application or web browser (e.g., by Apple Safari or Google Chrome) that may be running on user device 60 and that may be pointed to a uniform resource locator (“URL”) whose target or web resource may be managed by or otherwise affiliated with the APSP.

Subsystem 120 may be any portable, mobile, wearable, implantable, or hand-held electronic device configured to operate with system 101. Alternatively, subsystem 120 may not be portable during use, but may instead be generally stationary. Subsystem 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), a tag, credit card-shaped device, transponder, transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., watch, ring, glasses, etc.), boom box, internet of things (“IoT”) device, virtualized IoT device (e.g., cloud compute instance), modem, router, RFID card, printer, kiosk (e.g., a public kiosk that may be used to provide a personal virtual device by enrolling and/or authenticating various users through distinct enrollment and/or authentication processes), beacon (e.g., a Bluetooth low energy beacon transmitter device), server, and any combinations thereof. Subsystem 120 may be configured to have any physical structure (e.g., by one or more housings 11) that may include, but is not limited to, any suitable portable, mobile, wearable, implantable, rideable, controllable, or hand-held mobile electronic device (e.g., a portable and/or handheld media player), a headset, a helmet, glasses, a wearable, a tablet computer, a laptop computer, a controller, a VR and/or AR and/or MR device, a vehicle, server, sensor system, actuator system, and/or any other machine or device or housing or structure. Alternatively, subsystem 120 may not be portable during use, but may instead be generally stationary. In one or more implementations, one or more of processor 12, memory 13, sensor(s) 15, communications interface or communications component 14, V/O component 16, and/or power supply 17, and/or one or more portions thereof, may be implemented in software (e.g., subroutines and code), may be implemented in hardware (e.g., an application specific integrated circuit (“ASIC”), a field programmable gate array (“FPGA”), a programmable logic device (“PLD”), a controller, a state machine, gated logic, discrete hardware components, or any other suitable devices), and/or a combination of both.

Variations in the arrangement and type of the components may be made without departing from the spirit or scope of the claims as set forth herein. Additional components, different components, or fewer components may be provided.

APS subsystem 10 may communicate with one or more user devices 60 and/or network nodes 70 and/or third party enabler subsystem(s) 90 via one or more communications networks 50, and/or any user device 60 may communicate with any other user device 60 and/or network node 70 and/or subsystem 90 via one or more communications networks 50, and/or any network node 70 may communicate with any other network node 70 and/or user device 60 and/or subsystem 90 via one or more communications networks 50. Network 50 may be the internet or any other network for communicatively coupling any two entities or devices or subsystems of system 101 that may be remote from one another, such that when interconnected, a user device 60 may access information (e.g., an API, SDK, protocol, application, etc. (e.g., from data structure 19d of APS subsystem 10, as may be provided as an authentication processing service via processor 12 of APS subsystem 10)) as if such information were stored locally at that user device (e.g., in memory component 13 of that device).

A user device 60 may be configured to enroll and then authenticate itself and/or a user with the APSP of system 101 by following any suitable APSP protocols, such as by using any suitable client application (e.g., any suitable APSP-enabled application) that may be running on the user device alone or in conjunction with any node(s) 70 for helping authenticate a user device. For example, a client application 19 (e.g., an APSP app (e.g., as may be created and/or managed or otherwise at least partially under the auspices of APS subsystem 10)) may be run on a user device 60a that may include an APSP API and/or an APSP SDK, which may be at least partially defined by APS subsystem 10. An APSP API of a client application 19 may be configured to enable interaction with any suitable user device components (e.g., biometric sensors for capturing data (e.g., a camera for capturing images) indicative of the user's biometrics). An APSP SDK of a client application 19 may be configured to include or define a client-/user-side secure multi-party computation (“SMPC”) protocol engine and/or any suitable pseudorandom function family (“PRF”) (e.g., any suitable efficiently-computable function of the PRF and/or any suitable oblivious pseudorandom function (“OPRF”)) and/or a communication protocol for enabling interaction between the user device and various network nodes (e.g., for processing of a captured biometrics image and/or otherwise obtaining a biometric template or biometric sample or low min-entropy signal, and/or the like (e.g., to generate enrollment data and/or for recreation to prove authentication data)). Moreover, each one of network nodes 70 (e.g., nodes 70a-70c) may be configured to run any suitable application(s) (e.g., a respective node application) that may include any suitable SMPC/PRF engine(s) and/or any suitable APSP protocol(s), which may be at least partially defined by APS subsystem 100.

During APSP enrollment of a user U or a user device 60a of user U, which may be referred to herein as an APS user device 60a, device 60a or otherwise may be used to capture a user's biometrics ub or otherwise for obtaining any suitable low min-entropy signal ω/ω′ (e.g., a biometric signal, some reproducible hardware noise, etc.) or otherwise obtain such a signal for user enrollment and/or user authentication with the APSP. On the other hand, a TPS user device (e.g., TPS user device 60c) may or may not be used to capture a user's biometrics or otherwise for user enrollment and/or user authentication with the APSP but may nevertheless be used by a user to interact with a third party subsystem 90 that may benefit from the enrollment/authentication of the APSP, while a third party subsystem 90 may be configured to provide any suitable service for the APSP (e.g., a third party app or website browser or server of a third party website (e.g., a social network site or banking site) or an identity and access management (“IAM”) server, in any suitable sector (e.g., e-wallets, fintech, banking, enterprise, A&D/travel, healthcare, government, etc.), as may be described in U.S. Pat. Nos. 11,101,986 and 11,936,775, each of which is incorporated by reference herein in its entirety. APS subsystem 100 and/or third party subsystem 90 or any suitable repository subsystem 80 may be utilized by the system to store any suitable data (e.g., for associating a user identifier and/or device identifier with any suitable keys (e.g., using blockchain, distributed identities (“DIDs”), etc.)), such that the data may be accessible by various other entities of the system (e.g., via network 50) (e.g., for associating various device identifiers (e.g., various public device signing keys of various devices) with a particular user identifier (e.g., a public user key)). For example, such a repository may be distinct from each network node, or may be a network node, or may be a part of APS subsystem 100. APS user device 60a may be configured to capture any suitable user biometrics ub (e.g., user enrollment biometrics ueb or user authentication biometrics uab) of a device user U (e.g., using any suitable sensor(s) 15 and/or any other suitable features of that user device 60a). For example, during enrollment, the APS user device may be configured to capture any suitable user enrollment biometrics of the user, and those captured user enrollment biometrics may be used by the APS user device to generate an enrollment biometric template (“EBT”) ω (e.g., a user's face may be captured as an image by the user device (e.g., using a camera sensor), and a cropped and/or resized version of that image may be provided as input to a neural network to produce an embedding that may be used as the EBT (e.g., an EBT may be obtained as a feature vector from the captured user enrollment biometrics)). As another example, during authentication, the APS user device may be configured to capture any suitable user authentication biometrics of the user, and those captured user authentication biometrics may be used by the APS user device to generate an authentication biometric sample (“ABS”) ω′ (e.g., a user's face may be captured as an image by the user device (e.g., using a camera sensor), and a cropped and/or resized version of that image may be provided as input to a neural network to produce an embedding that may be used as the ABS (e.g., an ABS may be obtained as a feature vector from the captured user enrollment biometrics)). Although described herein with respect to a user's biometrics, it is understood that any suitable original signal(s) (e.g., a low min-entropy signal ω or ω′ (e.g., enrollment/authentication vectors)) may be generated based on any suitable biometrics, and/or the like as signals ub that may be indicative of any suitable metrics or characteristics of a user and/or a device controlled by the user.

After enrollment with the APSP, APS user device 60 may then be used to authenticate its user with the APSP. After enrollment, APS user device 60 may be configured to authenticate its user, first by capturing any suitable user authentication biometrics of its user that may then be used to generate an authentication biometric sample (“ABS”) ω′ (e.g., user authentication biometrics similar to the user enrollment biometrics used to generate the EBT of the enrollment (e.g., picture(s) of the user's face, scan(s) of the user's fingerprints, etc.)).

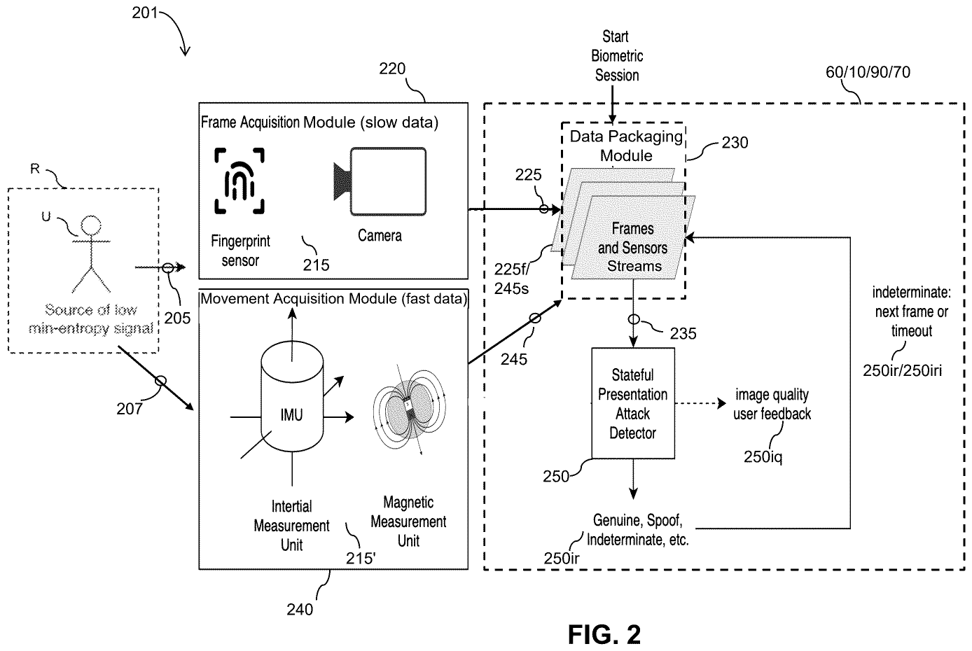

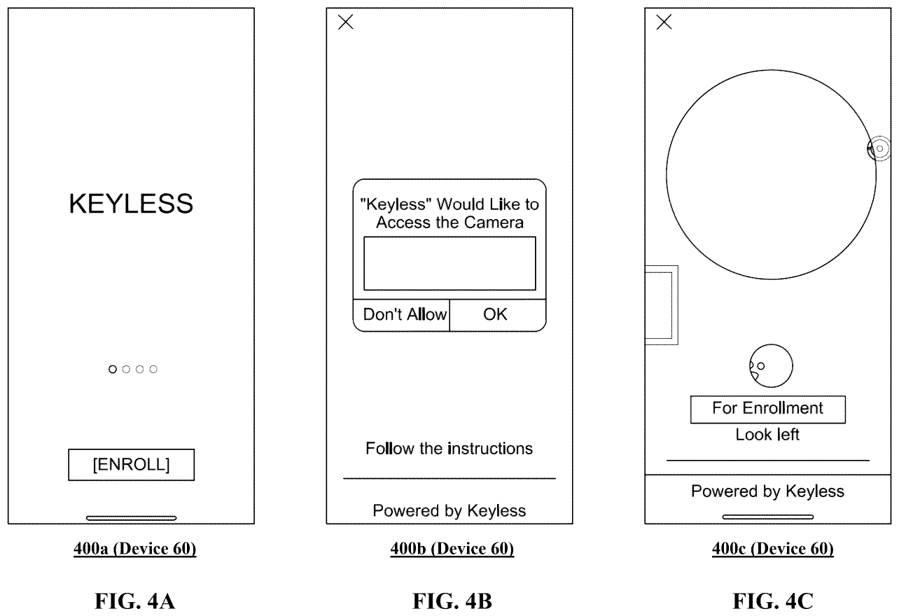

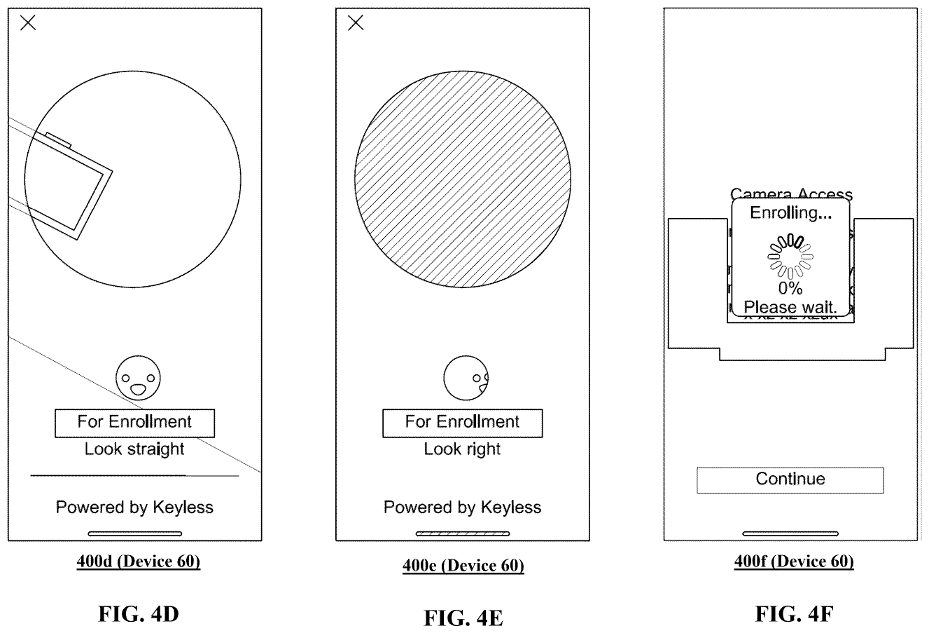

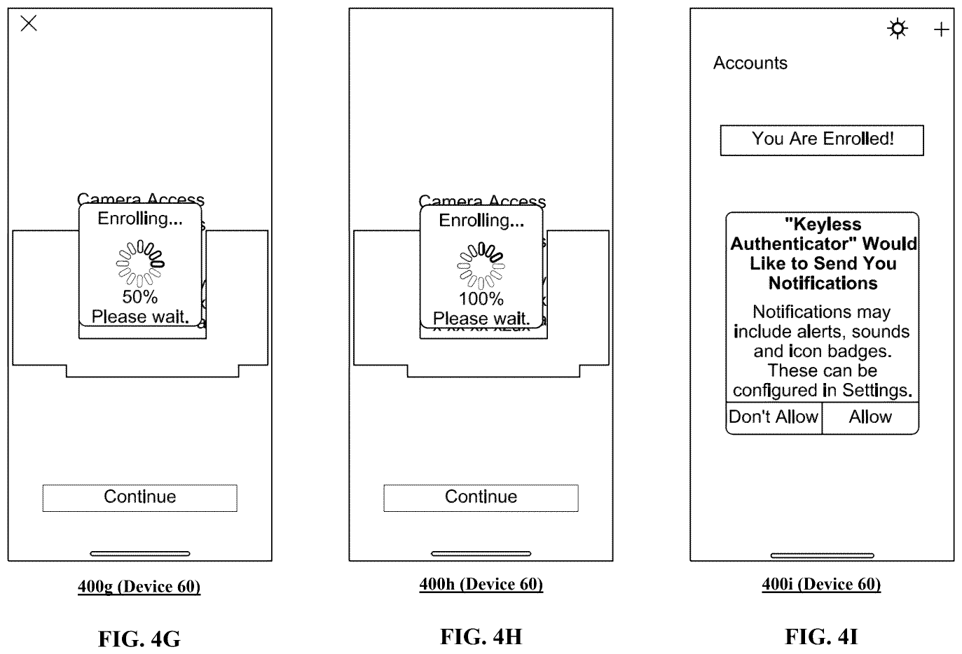

### FIGS. 2 and 4A-4I

Various arrangements of devices may be used for providing a useful system for implementing an APSP protocol of the disclosure. For example, as shown in FIG. 2, an APS system 201 may include or use any suitable original signal(s) source R for providing one or more original (e.g., low min-entropy) signals, including, but not limited to, a user U (e.g., a human being, pet, etc.), and/or the like that may generate or present any suitable biometrics evidence or biometrics signal(s) 205 (e.g., ub, ueb, uab, etc.) for capture as slow data or large data or biometric data or frame data or image data and/or that may generate or present any suitable movement evidence or movement signal(s) 207 for capture as fast data or small data or environmental data or movement data or motion data. System 201 may include any suitable frame acquisition module 220 (e.g., a slow data acquisition module or large data acquisition module or image data acquisition module) and any suitable movement acquisition module 240 (e.g., a fast data acquisition module or a small data acquisition module or a motion data acquisition module), each of which may be configured for capturing any suitable data from source R. For example, frame acquisition module 220 may include any suitable sensor(s) 215 (e.g., any suitable first type of sensor 15 of any suitable subsystem 120) that may be configured to capture biometrics evidence or biometrics signal(s) 205 from source R (e.g., source R's fingerprint, palm veins, palm print, hand geometry, face geometry, head geometry, iris, retina, and/or the like) and generate any suitable frame data or image data 225 therefrom, while movement acquisition module 240 may include any suitable sensor(s) 215′ (e.g., any suitable second type of sensor 15 of any suitable subsystem 120) that may be configured to capture movement evidence or movement signal(s) 207 from source R (e.g., source R's movement of module 240 within an environment) and generate any suitable movement data or motion data 245 therefrom. System 201 may include any suitable device, such as any suitable type of use device 60 (e.g., a smart mobile device (e.g., an iPhone™ by Apple Inc.), which may include a smart card and/or any suitable radio-frequency identification (“RFID”) chip), that may be provided for obtaining any suitable images or frames 225f (e.g., low min-entropy signal(s) or enrollment/authentication vector(s) ω/ω′ (e.g., EBT, ABS, etc.)) as data 225 from sensor(s) 215 based on the captured original biometrics evidence or biometrics signal(s) 205 (e.g., ub, ueb, uab, etc.) and any suitable movement signals or streams of movement and environment readings 245s as data 245 from sensor(s) 215′ based on the captured movement evidence or movement signal(s) 207 (e.g., stream of movement and environment readings of sensors 215′). In some embodiments, device 60 may include sensor(s) 215 of frame acquisition module 220 that may capture biometrics evidence or biometrics signal(s) 205 (e.g., a camera, a fingerprint sensor, and/or the like that may be built into or otherwise provided by the user device) and/or device 60 may include sensor(s) 215′ of movement acquisition module 240 that may capture movement evidence or movement signal(s) 207 (e.g., an inertial measurement unit, a magnetic measurement unit, an ambient light sensor, and/or the like that may be built into or otherwise provided by the user device). Additionally or alternatively, sensor(s) 215 of frame acquisition module 220 and/or sensor(s) 215′ of movement acquisition module 240 may be distinct from but communicatively couplable to device 60 (e.g., such sensor(s) 215 and/or sensor(s) 215′ may be provided by an APS subsystem or a third party subsystem or the like). In some embodiments, device 60 may be configured to process any captured original signals 205 for generating any suitable frame data 225 (e.g., any suitable frame(s) 225f (e.g., any suitable low min-entropy signal(s) or enrollment/authentication vector(s) ω/ω′)) and/or to process any signals 207 for generating any suitable movement data 245. Alternatively, any suitable remote component(s) or subsystem(s) may be configured to process any captured original signals 205 for generating any suitable frame data 225 and/or to process any signals 207 for generating any suitable movement data 245. Although not shown, system 201 may also include any suitable network or server node (e.g., node 70) or any suitable plural number of nodes (e.g., nodes 70a-70c) of a network (e.g., network 40) that may be in communication with user device 60.

User U may initiate enrollment by carrying out any suitable enrollment initiation interaction with an APS application 19 that may be running on device 60. For example, as shown by screen 400a of FIG. 4A, the UI of APS device 60 may present an “ENROLL” option for user U to select with its enrollment initiation interaction in order to proceed with a process for enrolling with the APSP. User U may present any suitable user enrollment biometrics ueb (e.g., as user enrollment biometric identifier information or user enrollment biometric information) to device 60 by carrying out any suitable user biometrics enrollment interaction with system 201 (e.g., module 220 and/or device 60). System 201 (e.g., module 220 and/or device 60) may be configured to capture such enrollment biometrics ueb for generating an enrollment biometric template (“EBT”) ω (e.g., according to an APS application 19 (e.g., different users may use different biometrics, different devices may use different sensors, different types of data may be captured in addition to biometrics (e.g., device environment data), and/or the set of characteristics and associated actions themselves may change from one enrollment to the next, etc.)). For example, as shown by screen 400b of FIG. 4B, the UI of APS device 60 may optionally present a user approval request for accessing any suitable sensor(s) or other device components (e.g., a camera of device 60 (e.g., a camera 215 of module 220)) for capturing user biometrics, a request which the user may accept or deny. If accepted or automatically allowed, the UI of APS device 60 may present instructions on how the user ought to present user enrollment biometrics ueb to user device 60 for capture. For example, as shown by one or more of screens 400c-400e of FIGS. 4C-4E, while the user's face (not shown) may be in the line of sight of a device camera sensor, device 60 may instruct the user to look left, then eventually look straight at the camera, and then eventually look right. This may enable system 201 (e.g., module 220 and/or device 60) to capture user enrollment biometrics ueb in the form of a video or photograph sequence of the user's face rotating. This may enable presentation attack detection and/or authentic biometric “liveness” detection of the user (e.g., as may instructing the user to carry out any other suitable action while biometrics are captured, such as winking with one eye then with the other eye, or smiling then frowning, or saying a word or phrase, etc.). This may help prevent spoofing and/or capturing biometrics of an unwilling user.

Any suitable biometrics of a user may be captured in any suitable manner by any suitable sensor(s) of user device 60 and/or module 220 in response to a user presenting itself to the user device in any suitable manner(s). For example, any information that may be sensed about the user by any sensor 15 and/or sensor 215 and/or sensor 215′ described herein or otherwise may be used to define the user enrollment biometrics ueb to be captured by system 201 (e.g., module 220 and/or module 240 and/or device 60), including, but not limited to, facial information, fingerprint information, iris information, retinal scan information, movement, orientation, gesture, gait, pausality, speech information, any suitable behavioral biometrics, sequenced DNA, and/or the like. Biometric traits may be physiological or behavioral characteristics that may uniquely identify a user. Because of the uniqueness of these traits, several authentication techniques based on biometric signals have been introduced, including with respect to biometrics modalities, including, but not limited to, fingerprints, face, iris, voice, speech, keystroke dynamics, and/or the like. Biometrics may capture intrinsic characteristics of the user (e.g., something that the user is), thus removing the need for a user to memorize any secret (e.g., a password or PIN), or to possess a physical device (e.g., a hardware token or a smart card, although still possible). The experience may typically be more user-friendly than other modalities. Further, biometric authentication may generally be more secure than passwords, whereas the security of biometric authentication systems is largely independent of the user's choices and behavior.

However, biometric signals may be somewhat noisy. For example, multiple measurements collected from the same user may tend to vary slightly due to several factors, including, but not limited to, sensor noise, changes in collection environment (e.g., environmental lighting when enrollment biometric template (“EBT”) ω is captured may be different than environmental lighting when an authentication biometric sample (“ABS”) ω′ is captured), changes in collection sensors (e.g., a device used to capture EBT may be different than a device used to capture ABS), and natural variations in the physiological characteristic being sampled (e.g., user without beard to capture EBT different than user with beard to capture ABS). For instance, the image collected from a fingerprint may change between samples because of the amount of pressure of the finger on the sensor, the angle at which the finger touches the sensor, and skin dryness. Similarly, individual pixels of the images used for face authentication may be affected by lighting, the position of the user's face within the frame, presence of facial hair, and/or the like (e.g., the user may grow a beard between when its enrollment biometrics are captured for generating EBT ω and when its authentication biometrics are captured for generating ABS ω′). Therefore, because of this noise, the APSP may be configured not to directly compare or otherwise use raw biometric signals (e.g., pixels in a fingerprint image of a user's enrollment biometrics and pixels in a fingerprint image of a user's authentication biometrics). Instead, the APSP may be configured to extract relevant features from the raw signals (e.g., the relative location and the orientation of minutiae points in fingerprint images) and match or otherwise use these features using any suitable pattern recognition systems. For example, system 201 (e.g., module 220 and/or module 240 and/or device 60) may not only be configured to capture user enrollment biometrics ueb (e.g., raw biometric signals), but may also be configured to generate an enrollment biometric template (“EBT”) B based on such captured user enrollment biometrics ueb using any suitable techniques (e.g., according to application 19). For example, if captured ueb is an image of the user's face, device 60a may be configured to perform a tight square crop containing the user's face, scale it to 160 x160 pixels, and then feed the pre-processed image into a convolutional neural network (e.g., that may be run on device 60a) that may produce an embedding for constituting EBT ω for the user's captured ueb (e.g., for an image x, the embedding may be represented as f(x)∈ [symbol] ^{d}, which may embed x into a d-dimensional Euclidean space, and the network nodes and/or otherwise may be trained (e.g., by the SMPC protocol) such that the Euclidean distances (e.g., closenesses) in the embedding space when evaluating the user's EBT with respect to an ABS may correspond to the face similarity (e.g., such that faces of same person have smaller distances and faces of different persons have larger distances)). Therefore, in some embodiments, system 201 (e.g., module 220 and/or module 240 and/or device 60) may be configured to use a neural network or otherwise to process captured ueb into one or more vectors for defining EBT B, such that the vector(s) of such an EBT B may later be compared to vector(s) of an ABS for computing a distance therebetween (e.g., with a matching function of an SMPC). However, any suitable enrollment biometrics ueb may be used in any suitable manner to define any suitable enrollment biometric template ω (e.g., fingerprint biometrics ueb may be transferred into a set as EBT ω). Generally, data may be collected from any or all sensors of the user device and/or of any other suitable device of the APSP for any amount of time (e.g., while asking the user to cooperate or in the background without explicitly asking for the user's cooperation (e.g., when sensing the gait of a user that may be walking while carrying the device)), then a subset of the raw collected data may be selected based on any suitable data quality check(s), and then the raw data (e.g., subset or otherwise) may be processed using any suitable algorithms (e.g., legacy feature extraction, machine learning, etc.) and/or encoding of time-series information (e.g., for liveness checks (e.g., as may be distinct from snap-shot image data)). For example, this may reveal a set and/or vector and/or matrix and/or the like that may be used to define EBT @, as any suitable representation (e.g., string of bits or digital representation) of the sensed data (e.g., user biometric data and/or device environmental data). As shown, screens 400f-400h of FIGS. 4F-4H may be provided by application 19 of device 60 during such enrollment, but screen 400i of FIG. 4I may be presented when such enrollment is complete and confirmed, at which time a user may be presented with any suitable enrolled options (e.g., whether or not to enable push notifications from the APSP on the enrolled device).

User U may present user authentication biometrics uab (e.g., as user authentication biometric identifier information or user authentication biometric information) to system 201 (e.g., module 220 and/or module 240 and/or device 60) by carrying out any suitable user biometrics authentication interaction with system 201 (e.g., module 220 and/or module 240 and/or device 60), which may be configured to capture such authentication biometrics uab for generating an authentication biometric sample (“ABS”) ω′ (e.g., according to any suitable APS application 19). For example, the UI of APS device 60 may present instructions on how the user ought to present user authentication biometrics uab to system 201 (e.g., module 220 and/or module 240 and/or device 60) for capture (e.g., similarly to as shown by one or more of screens 400c-400e of FIGS. 4C-4E with respect to enrollment biometrics capture). This may enable system 201 (e.g., module 220 and/or module 240 and/or device 60) to capture user authentication biometrics uab in the form of a video or photograph sequence of the user's face rotating. This may enable “liveness” detection of the user (e.g., as may instructing the user to carry out any other suitable action while biometrics are captured, such as winking with one eye then with the other eye, or smiling then frowning, or saying a word or phrase, etc.). This may help prevent spoofing and/or capturing biometrics of an unwilling user. Just as any suitable enrollment biometrics web of a user may be captured in any suitable manner(s) by any suitable sensor(s) of system 201 (e.g., module 220 and/or module 240 and/or device 60) in response to a user presenting itself to the user device in any suitable manner(s), any suitable authentication biometrics uab of a user may be captured in any suitable manner(s) by any suitable sensor(s) of system 201 (e.g., module 220 and/or module 240 and/or device 60) in response to a user presenting itself to the user device in any suitable manner(s) (e.g., according to an APS application of the APS device). Moreover, just as any suitable EBT ω may be generated in any suitable manner(s) using any suitable enrollment biometrics ueb of an enrollment process, any suitable ABS ω′ may be generated in any suitable manner(s) using any suitable authentication biometrics uab of an authentication process (e.g., according to an APS application of the APS device). As mentioned, system 201 (e.g., module 220 and/or module 240 and/or device 60) may use any suitable neural network(s) to process captured ueb for defining EBT ω. Similarly, system 201 (e.g., module 220 and/or device 60) may use any suitable neural network(s) to process captured uab for defining ABS ω′, where such neural network(s) used during authentication may be the same as or different than the neural network(s) used during enrollment. However, the manner in which enrollment biometrics are captured may differ in any suitable way(s) from the manner in which the authentication biometrics are captured (e.g., the amount of information captured (e.g., the quality or resolution of the capture) may be less for the ABS than for the EBT). For example, this may help ensure high quality of an enrollment template and, as such, less false rejects and false accepts during authentications, while the differences can include, but are not limited to, amount of data captured, possible additional/different collaboration from the user, possible quality checks and repeated capture of data, other processing techniques, and/or the like.

In some embodiments, rather than generating an EBT @ based on captured user enrollment biometrics ueb (e.g., as user enrollment biometric identifier information or user enrollment biometric information, which may be indicative of a user's physiological and/or behavioral characteristics, as captured by one or more suitable sensors of the APS user device), the EBT @ may additionally or alternatively be generated during an APS enrollment process based on any suitable enrollment device movement and/or environmental data that may be captured by any suitable sensors of the APS user device as indicative of any suitable characteristic(s) of the device movement and/or environment and/or that may be provided to the APS user device from any suitable third party source. Moreover, rather than generating an ABS ω′ based on captured user authentication biometrics uab (e.g., as user authentication biometric identifier information or user authentication biometric information, which may be indicative of a user's physiological and/or behavioral characteristics, as captured by one or more suitable sensors of the APS user device), the ABS ω′ may additionally or alternatively be generated during an APS authentication process based on any suitable authentication device movement and/or environmental data that may be captured by any suitable sensors of the APS user device (e.g., concurrently with any captured user authentication biometrics uab) as indicative of any suitable characteristic(s) of the device movement and/or environment.

Therefore, the success or failure of any evaluation of EBT ω and ABS ω′ (e.g., comparison thereof) may be based on a determined closeness between the enrollment device environmental data of the EBT wω and the authentication device environmental data of the ABS ω′ (if not also on a determined closeness between the user enrollment biometrics ueb of the EBT ω and the user authentication biometrics uab of the ABS ω′). Such movement data and/or environmental data may be any suitable data indicative of any suitable characteristic(s) of the movement and/or environment of the APS user device (e.g., device capturing user biometric data), including, but not limited to, location, temperature, air quality, light quality, sound quality, altitude, data captured by wireless sensor(s), movement, and/or the like.

Additionally or alternatively, prior to using any user enrollment biometrics ueb and/or any user authentication biometrics uab for enrolling and/or authenticating a user (e.g., prior to using any captured image data of those biometrics for enrollment or authentication), the system may be configured to capture and analyze any suitable movement data and/or environmental data associated with such image data over a period of time to determine whether the image data is likely part of a presentation attack or spoofing attempt. Therefore, a presentation attack detector may be configured to accept user input in the form of any suitable biometric sample image frames, which may be fed (e.g., one by one) into any suitable system of the disclosure, such as a system 201 of FIG. 2, along with any suitable environmental and/or movement data from the same time as the image frames. For example, as shown in FIG. 2, system 201 may include any suitable presentation attack detector 250 that may be configured to receive any suitable frame data 225 (e.g., any suitable frame(s) 225f) from any suitable source(s) (e.g., from any suitable frame acquisition module(s) 220 and/or sensor(s) 215) and any suitable movement data 245 (e.g., any suitable movement and environment readings 245s) from any suitable source(s) (e.g., from any suitable movement acquisition module(s) 240 and/or sensor 215′), where such image data 225 and such movement data 245 may be provided to detector 250 by any suitable data packaging module 230 as at least a part of any suitable biometric data package(s) 235.

In some embodiments, a frame 225f may be a biometric sample image frame. A biometric sample image frame may be a single capture of a biometric instance within a particular timeframe. For example, for camera-based biometric systems (e.g., face recognition systems, iris recognition systems, fingerprint recognition systems, etc.) or for a camera-based frame acquisition module with at least one suitable camera-type sensor 215, a frame may be a single image captured by such a camera within an image capture timeframe that may be defined by a shutter speed of the camera, by frame processing time of the device (e.g., within hardware of the device), and/or the like. Biometric instances may include, but are not limited to, facial images (e.g., faceprints), fingerprint patterns, iris scans, and/or any other suitable types of biometric data. A biometric instance may be a head, face, a fingertip, an iris, a retina, a palm, veins, or other suitable body part of a user U that may be provided (e.g., presented) by user U as original signal(s) or evidence 205 that may be captured by module 220 (e.g., photographed by a camera sensor 215 of module 220) during a particular image capture timeframe (e.g., during a timeframe (e.g., a timeframe defined by module 220 (e.g., a timeframe that may be defined by a shutter speed of a camera sensor 215 of module 220) or otherwise)).

A duration of time spanning at least two successive image capture timeframes may be a package capture timeframe not only during which module 220 may capture each of the at least two frames 225f of image data 225 of the package capture timeframe but also during which module 240 may capture any suitable amount or all of the stream of movement and/or environment readings 245s of motion data 245 of the package capture timeframe. As an example, every time two consecutive image data frames 225f of image data 225 may be captured by a sensor 215 of module 220, the system may also capture an entire stream of movement and/or environment readings 245s of motion data 245 provided by one, some, or each available sensor 215′ of module 240 during that package capture timeframe. Specifically, when a first image data frame 225f of image data 225 (frame A) is captured at a first image capture time of a sensor 215 (time TA), a second image data frame 225f of image data 225 (frame B) is captured at a second image capture time of a sensor 215 (time TB) consecutively after the first image capture time, a third image data frame 225f of image data 225 (frame C) is captured at a third image capture time of a sensor 215 (time TC) consecutively after the second image capture time, a fourth image data frame 225f of image data 225 (frame D) is captured at a fourth image capture time of a sensor 215 (time TD) consecutively after the third image capture time, a fifth image data frame 225f of image data 225 (frame E) is captured at a fifth image capture time of a sensor 215 (time TE) consecutively after the fourth image capture time, and a sixth image data frame 225f of image data 225 (frame F) is captured at a sixth image capture time of a sensor 215 (time TF) consecutively after the fifth image capture time, a first stream of readings 245s of motion data 245 (stream A-B) may be captured during a first package capture timeframe (timeframe TA-TB) extending between first image capture time TA and second image capture time TB, a second stream of readings 245s of motion data 245 (stream B-C) may be captured during a second package capture timeframe (timeframe TB-TC) extending between second image capture time TB and third image capture time TC, a third stream of readings 245s of motion data 245 (stream C-D) may be captured during a third package capture timeframe (timeframe TC-TD) extending between third image capture time TC and fourth image capture time TD, a fourth stream of readings 245s of motion data 245 (stream D-E) may be captured during a fourth package capture timeframe (timeframe TD-TE) extending between fourth image capture time TD and fifth image capture time TE, and a fifth stream of readings 245s of motion data 245 (stream E-F) may be captured during a fifth package capture timeframe (timeframe TE-TF) extending between fifth image capture time TE and sixth image capture time TF, whereby, every time a pair of sequential image data frames are acquired from one or more sensors 215, readings of motion data instances may be acquired from one or more sensors 215′ during the timeframe between the capture of each image data frame of the pair and all such acquired image data and all such acquired motion data may be combined into a package. If a system has more than one active sensor 215 of a module 220, each active sensor 215 may generate image data frames for use in such packages, and/or if a system has more than one active sensor 215′ of a module 240, each active sensor 215′ may generate motion data for use in such packages. For the sake of simplicity, only one instance of each of data 225 and data 245 are shown in FIG. 2, but two or more instances of each may be provided by modules 220 and 240 to an instance of a data packaging module 230 for use in defining a single package 235 for a particular package capture timeframe.

Data packaging module 230 may be configured to define biometric data packages 235 in one of various ways, where each biometric data package 235 may be defined to include at least two sequential image data frames from one, some, or each active sensor 215, the first and last of which may define a package capture timeframe of the package during which motion data from one, some, or each active sensor 215′ may be used to further define the package. For example, in some embodiments, a first package 235 (package a) may be defined to include a first pair of consecutive image data frames 225f of motion data 225 (frame A and frame B) and the stream 245s of motion data 245 captured during the package capture timeframe associated with that pair of image data frames (stream A-B of timeframe TA-TB), while a second package 235 (package β) may be defined to include a second (next) pair of consecutive image data frames 225f of motion data 225 (frame B and frame C) and the stream 245s of motion data 245 captured during the package capture timeframe associated with that pair of image data frames (stream B-C of timeframe TB-TC), while a third package 235 (package y) may be defined to include a third (next) pair of consecutive image data frames 225f of motion data 225 (frame C and frame D) and the stream 245s of motion data 245 captured during the package capture timeframe associated with that pair of image data frames (stream C-D of timeframe TD-TD), whereby every consecutive pair of image data frames 225f may be used to define its own package 235 along with the motion data stream 245s of the package capture timeframe for that consecutive pair of image data frames. As another example, in some other embodiments, a first package 235 (package α′) may be defined to include a first pair of sequential but not consecutive image data frames 225f of motion data 225 (frame A and frame C) and the stream 245s of motion data 245 captured during the package capture timeframe associated with that pair of image data frames (stream A-C of timeframe TA-TC), while a second package 235 (package β′) may be defined to include a second (next) pair of sequential but not consecutive image data frames 225f of motion data 225 (frame B and frame D) and the stream 245s of motion data 245 captured during the package capture timeframe associated with that pair of image data frames (stream B-D of timeframe TB-TD), whereby a pair of image data frames 225f that is sequential but not consecutive in some fashion (e.g., skips one sequential frame) may be used to define its own package 235 along with the motion data stream 245s of the package capture timeframe for that sequential pair of image data frames. As another example, in some other embodiments, a first package 235 (package a“) may be defined to include a first group of three or more sequential and potentially consecutive image data frames 225f of motion data 225 (frame A, frame B, and frame C) and the stream 245s of motion data 245 captured during the package capture timeframe associated with that group of image data frames (stream A-C of timeframe TA-TC), while a second package 235 (package ß”) may be defined to include a second group of three or more sequential and potentially consecutive image data frames 225f of motion data 225 (frame B, frame C, and frame D) and the stream 245s of motion data 245 captured during the package capture timeframe associated with that group of image data frames (stream B-D of timeframe TB-TD) or while an alternative second package 235 (package β′″) may be defined to include a second group of three or more sequential and potentially consecutive image data frames 225f of motion data 225 (frame D, frame E, and frame F) and the stream 245s of motion data 245 captured during the package capture timeframe associated with that group of image data frames (stream D-F of timeframe TD-TF), or while a first package 235 (package α″″) may be defined to include a first group of three or more sequential and potentially consecutive image data frames 225f of motion data 225 (frame A, frame C, and frame E) and the stream 245s of motion data 245 captured during the package capture timeframe associated with that group of image data frames (stream A-E of timeframe TA-TE), while a second package 235 (package β″″) may be defined to include a second group of three or more sequential and potentially consecutive image data frames 225f of motion data 225 (frame B, frame D, and frame F) and the stream 245s of motion data 245 captured during the package capture timeframe associated with that group of image data frames (stream B-F of timeframe TB-TF), and/or the like, whereby a group of three or more image data frames 225f that are sequential but not necessarily consecutive in some fashion may be used to define its own package 235 along with the motion data stream 245s of the package capture timeframe for that group of image data frames. Therefore, a package's package capture timeframe need not be bound by the timing of consecutive image data frames, but instead the package may include two or more sequential but not necessarily consecutive image data frames (e.g., three consecutive image data frames or two sequential but not consecutive image data frames), whereby more movement acquisition instances of motion data 245 may be included in packages with longer package capture timeframes (e.g., the process of generating the package may be longer but the package may include more information (e.g., more accurate but slower)). The time difference between the capture of two consecutive image data frames of a sensor as used by the system may be dynamic or fixed (e.g., based on specific sensor hardware and/or ambient conditions (e.g., ambient lighting conditions)), such that the package capture timeframes of consecutive packages may vary.

Data packaging module 230 may be provided by any suitable component(s) that may be configured to gather, buffer, synchronize, and package any suitable image data frames 225f of image data 225 from any suitable sensor(s) 215 and any suitable stream(s) 245s of motion data 245 from any suitable sensor(s) 215′ into one or more suitable biometric data packages 235 for use by detector 250. Image data 225 (e.g., biometric data or frame data or image data) may be considered slow data or large data as compared to motion data 245 (e.g., environmental data or movement data), which may be considered fast data or small data, because an image data frame 225f of image data 225 may be generated at a frequency slower than that of an instance motion data 245 and/or at a size greater than that of an instance of motion data 245. For example, an instance of image data 225 (e.g., an image data frame 225f from a sensor 215) may be a set of two-dimensional data values of image/visual data of any suitable size (e.g., 10 thousand pixels (100 pixels by 100 pixels in an image array), 1 million pixels, 10 mega pixels, and/or the like) depending on the resolution of a camera sensor 215 (e.g., 15,000 pixels may be enough for generating a biometric template)), which may be captured by an image sensor 215 at any suitable frequency (e.g.,1, 2, 3, 4, 50, 100, or even 1,000 times per second (e.g., a camera image sensor 215 may capture 10-30 frames per second)), while an instance of motion data 245 (e.g., a smallest unit of a stream 245s of motion data 245 from a sensor 215′) may be a one-dimensional data value of direction and magnitude vectors of any suitable size (e.g., 2 bits, 4 bits, 8 bits, 16 bits, 24 bits, etc.), which may be captured by a movement sensor 215′ at any suitable frequency (e.g., 100, 500, 1,000, 5,000, or even 10,000 times per second (e.g., a gyroscope motion sensor 215′ may capture 500 vectors per second)). A camera may produce a stream of images, and each image may have two or more dimensions (e.g., 6,240 pixels×4,160 pixels image (e.g., 25,958,400 pixels)) and may be generated 30 times per second, while a gyroscope may produce a stream of one or more instances of one-dimensional vectors (e.g., 3 one-dimensional values or real numbers (e.g., movement along an X-axis, movement along a Y-axis, and movement along a Z-axis)) may be generated 500 times per second, while an accelerometer may produce a stream of instances of one or more one-dimensional values (e.g., 3 one-dimensional values or real numbers (e.g., movement about an X-axis, movement about a Y-axis, and movement about a Z-axis)) may be generated 500 times per second, while an ambient light sensor may produce a stream of instances of a value of ambient light amount detected at a high rate per second, and while a magnetometer may produce a stream of one or more instances of one-dimensional vectors (e.g., 6 one-dimensional values or real numbers (e.g., direction of magnetic field along an X-axis, direction of magnetic field along a Y-axis, direction of magnetic field along a Z-axis, and a strength of each magnetic field)) may be generated at a high rate per second, such that a relatively large amount of visual data may be captured less frequently while also capturing a more continuous stream of a relatively small amount of movement data (e.g., motion and/or environmental data). Therefore, a system may be configured such that a large number of movement acquisition instances of motion data 245 of a smaller size from each of one or more particular movement sensors 215′ may be captured during the timeframe between two consecutive frame acquisition instances of image data 225 of a larger size from each of one or more particular image sensors 215, and the system may be configured to package some or all frame acquisition data and movement acquisition data associated with a particular package capture timeframe into a particular data package 235, where one or more data packages 235 for one or more sequential package capture timeframes may be provided sequentially over time to detector 250 (e.g., for detecting the likelihood of a presentation attack) and/or otherwise to the system (e.g., for defining an enrollment biometric template or an authentication biometric sample). For example, if a system is running a first camera 215 (e.g., a visible light camera) to capture a user's face as first image data 225 and a second camera 215 (e.g., a laser sensor camera (e.g., LIDAR)) to capture the user's face as second image data 225 and a gyroscope 215′ and an accelerometer 215′ and an ambient light sensor 215′ all at the same time, the first camera may produce first image data frames 225f, while the second camera may produce second image data frames 225f, while the gyroscope may produce its own stream 245s of instances of motion/environment data, while the accelerometer may produce its own stream 245s of instances of motion/environment data, and while the ambient light sensor may produce its own stream 245s of instances of motion/environment data, such that data packaging module 230 may generate one or more packages 235, each of which may be generated by synchronizing and bundling two or more sequential image data frames 225f from each of the first camera and the second camera (e.g., a first image data frame from each of the two cameras at a first image capture time of the cameras and at least a second image data frame from each of the two cameras at a sequentially later second image capture time of the cameras) along with (i) a stream 245s of gyroscope data instances captured during the package capture timeframe (e.g., a timeframe defined by the first image capture time (or just before or after that image capture time (e.g., depending on internal time clocks of the pertinent sensors/processors)) and the second image capture time or the latest image capture time associated with an image data frame of the package (or just before or after that image capture time (e.g., depending on internal time clocks of the pertinent sensors/processors)) and (ii) a stream 245s of accelerometer data instances captured during the package capture timeframe and (iii) a stream 245s of ambient light sensor data instances captured during the package capture timeframe. One such package 235 or two or more sequential iterations of such a package 235 over time may be generated by data packaging module 230 and provided to detector 250 for use in making some determination(s) with respect to a presentation attack. In some embodiments, a package may only include one frame acquisition instance of image data 225 (e.g., a single image data frame 225f from each of one or more available sensors 215) and any stream of motion data (e.g., stream 245s) that may be captured in a package timeframe that may extend backward from the time the package's image data was captured to the time that a consecutively previous package's image data was captured, whereby a package need not include two sequential frame acquisition instances (e.g., when detector 250 may be stateful and store any suitable data associated with one or more previous packages). In some embodiments, a package may not include any image data 225 but instead may only include motion data 245 (e.g., any motion data received since the last package).

Data 245 may include any suitable data that may be made accessible from a user device, including, but not limited to, location data (e.g., GPS data of the device's location), temperature/weather data of the device's environment (e.g., from any suitable device sensors and/or third party weather services in combination with the device's location), air quality data, light quality data, sound data (e.g., sound detected in the device's environment), altitude data, wireless communication component data, movement data, and/or the like. Any such data may be used for training any suitable model(s) or otherwise of detector 250 and as input for detector 250. Detector 250 may be configured to run an instance of its presentation attack detection process for each new package 235 received by the detector.

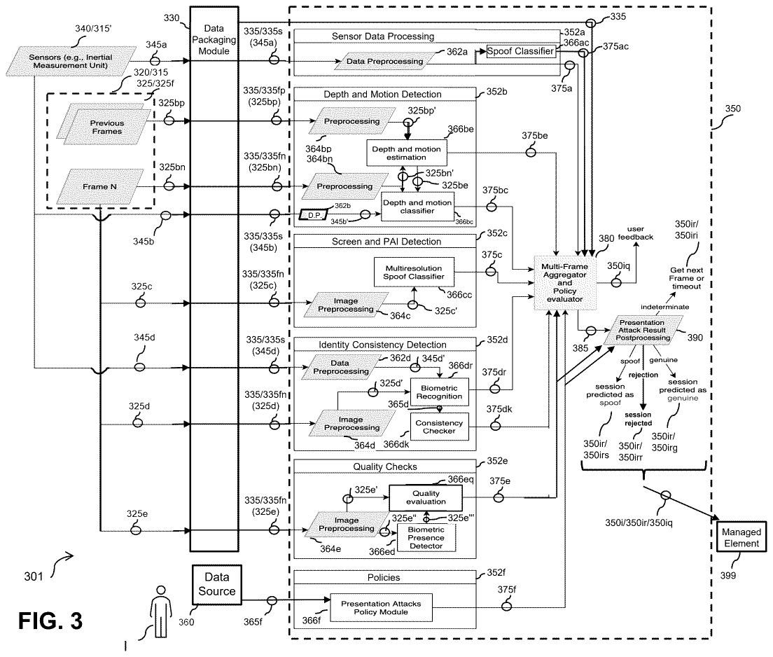

System 201 of FIG. 2 may include detector 250, any suitable sensor(s) 215/215′ of any suitable module(s) 220/240, module 230, any suitable processor(s), any suitable memory, any suitable application(s), any suitable input/output component(s), any suitable power source(s), any suitable communication component(s), and/or the like (e.g., as may be described with respect to any suitable subsystem(s) 120). One or more data packages 235 for one or more sequential package capture timeframes may be provided sequentially over time by data packaging module 230 to presentation attack detector 250 for use in detecting the likelihood of a presentation attack, whereby presentation attack detector 250 may be used as a gatekeeper before allowing some or all of the data from one or more of the data packages 235 to be used for defining an enrollment biometric template or an authentication biometric sample (e.g., the system may be configured to require that detector 250 first detect a satisfactory likelihood of no presentation attack based on one or more data packages 235 prior to enabling the system to use data from such data package(s) for defining an enrollment biometric template or an authentication biometric sample). As an example, a user may hold up their user device 60 (e.g., portable media device (e.g., iPhone)) to take a video of themselves by capturing sequential image data frames 245f using one or more image sensors 215 of device 60, while any other suitable sensors of device 60 (e.g., motion and/or environment sensors (e.g., sensor(s) 215′)) may capture streams 245s of any suitable instances of motion data 245, whereby any suitable data packaging module(s) 230 (e.g., of device 60) may generate one or more suitable data packages 235 using such image data 225 and such motion data 245, and whereby any suitable presentation attack detector module(s) 250 (e.g., of device 60) may process such data package(s) 235 in any suitable manner to make any suitable presentation attack determination(s). All such capturing, packaging, and processing may be carried out locally on a user's device 60 (e.g., without any access to remote servers (e.g., without active internet access)). Alternatively, some or all of such capturing, packaging, and/or processing may be carried out remotely from a personal APS user device (e.g., using a public airport kiosk (e.g., a TPS user device) with or without an internet connection to an APS server, using one or more remote processing subsystem(s) (e.g., using one or more of an APS subsystem, one or more third party subsystem(s), one or more network nodes, and/or the like), and/or the like). In some embodiments, each one of modules 220, 230, 240, and 250 may be provided entirely on any suitable user device 60. In other embodiments, modules 220 and 240 may be provided by any suitable user device 60, while modules 230 and 250 may be provided on any suitable APS subsystem 10, on any suitable third party subsystem 90, and/or on one or more network nodes 70 (e.g., in any suitable partially distributed or completely distributed fashion). In some embodiments, different submodules of a module (e.g., different ones of modules 352a, 352b, 352c, 352d, 352e, 352f, 380, and 390 of detector 350) may be provided on respective different devices (e.g., module 352a may be on a first node 70a while module 352b may be on a second node 70b, etc.) or on the same device (e.g., each one of modules 352a, 352b, 352c, 352d, 352e, 352f, 380, and 390 of detector 350 may be on a first node 70a). In some embodiments, certain data 225 and/or data 245 may be provided by a third party (e.g., a subsystem 90 may be operated by a bank and may provide image data 225 to a detector 250 (e.g., that may be running on any suitable device 60, APS subsystem 10, node(s) 70, and/or the like), where such image data may be video or still image data that the bank obtained from a client at any suitable time in the past (e.g., even years before providing it to the detector). An output of detector 250 may be provided (e.g., as an output from an API (e.g., as a JavaScript Object Notation (“JSON”) response, an Extensible Markup Language (“XML”) response, etc.)) to and used by any suitable target (e.g., a managed element 399 of FIG. 3), where such a target may be any suitable user device 60, any suitable APS subsystem 10, any suitable third party subsystem 90, and/or one or more network nodes 70.

A presentation attack detector may be configured to work on multiple samples provided within a single authentication session. An authentication session may start, for example, when a user may request to be authenticated, or when an application may request a user to authenticate. When an authentication session is started, a data packaging module may begin to gather, buffer, synchronize, and package any suitable image data frames of image data from any suitable image sensor(s) and any suitable stream(s) of motion/environment data from any suitable motion/environment sensor(s) into one or more suitable biometric data packages for use by a presentation attack detector. An authentication session may end, for example, when one or more biometric data packages are determined by a presentation attack detector to meet a satisfactory likelihood of no presentation attack and any suitable user biometric data from such biometric data packages (e.g., one or more signal(s) 205 as data 225) as may be provided by the user have been deemed genuine and have been successfully matched against a pre-recorded biometric template of the user (e.g., an enrollment biometric template (e.g., an enrollment biometric template (“EBT”) ω)).

Presentation attack detector 250 may be configured to estimate some presentation attack likelihood or patterns in both image data 225 and motion data 245 of one or more sequential data packages 235 (e.g., suspicious images, motion readings, etc.). Additionally or alternatively, presentation attack detector 250 may be configured to compare and correlate any motion data 245 (e.g., continuous readings of motion data streams) to changes in image data frames of image data 225 acquired in 225, thereby combining these two data streams to make better detections. As shown and described in more detail with respect to system 301 of FIG. 3, a presentation attack detector module (e.g., detector 250 of FIG. 2, detector 350 of FIG. 3, and/or the like) may include or otherwise utilize one or more detector models of any suitable type for any suitable purpose. Each detector model may be a learning engine. Each detector model may be configured to process one or more inputs for providing one or more outputs (e.g., by extracting unnecessary data). A model may be a machine learning model (e.g., a mathematical model that, after being trained on a given dataset, can be used to make predictions or classifications on new data (e.g., during training, a learning algorithm may be configured to iteratively adjust the model's internal parameters to minimize errors in its predictions)) and/or any other suitable model (e.g., a handcrafted model). A model may be a classifier model (e.g., a system that may be configured to generate an output related to a fixed number (e.g., 5) of possible outcomes or classes (e.g., an output that is indicative of a particular one of the fixed classes that the system has determined to be most likely based on the input(s) (e.g., an output indicative of a determination that class 3 of the 5 classes is most likely), an output that is indicative of a likelihood for each of the classes as determined by the system based on the input(s) (e.g., an output indicative of a determination that the 1^{st} class is 10% likely, that the 2^{nd} class is 12% likely, that the 3^{rd} class is 45% likely, that the 4^{th} class is 23% likely, and that the 5^{th} class is 10% likely), and/or the like)) or an extractor model (e.g., a depth/motion (e.g., map) extractor model) or an estimator or recognizer model (e.g., an identity estimator or recognizer model) or a detector model (e.g., a presence detector model) and/or the like. One or more models (e.g., a multi-frame aggregator classifier model) may be stateful (e.g., the model's internal state may be changed with every new set of input(s) (e.g., with every new data package (e.g., package of new image data and/or motion data)) such that the model may be accumulating and aggregating its individual predictions in order to produce better future decisions/predictions), while other models may not be stateful (e.g., the model has no memory and may restart with every new set of input(s)). Every iteration of use of a presentation attack detector may process a new set of input(s) (e.g., a new data package from a data packaging module). Some models of a presentation attack detector may be configured (e.g., trained) to work with input(s) provided by motion/environment data (e.g., fast data) of a new data package and not with input(s) provided by image data (e.g., slow data) of the new data package, while some other models of a presentation attack detector may be configured (e.g., trained) to work with input(s) provided by image data (e.g., slow data) of a new data package and not with input(s) provided by motion/environment data (e.g., fast data) of the new data package, while yet some other models of a presentation attack detector may be configured (e.g., trained) to work with input(s) provided by image data (e.g., slow data) of a new data package and also with input(s) provided by motion/environment data (e.g., fast data) of the new data package, and/or while yet some other models of a presentation attack detector may be configured (e.g., trained) to work with input(s) provided by output(s) of other model(s) of the presentation attack detector.

A presentation attack detector (e.g., detector 250 or one or more models of such a detector) may be configured to be stateful (e.g., it may maintain contextual information on the biometric data being fed into the system as subsequent data packages are submitted). In addition to processing each data package independently, a presentation attack detector (e.g., detector 250) may be configured to aggregate information from all the supplied data packages to develop a comprehensive understanding of the presented biometric data (e.g., from all image data frames of the packages). Additionally or alternatively, a system (e.g., system 201) may be configured to assess the image quality of each data package (e.g., of each image data frame of the data packages). Additionally or alternatively, a system (e.g., system 201) may be configured to aggregate quality information from one or more data packages into a stateful presentation attack detector (e.g., detector 250). This may allow the detector to identify patterns, trends, anomalies, and/or the like across a sequence of data packages that may indicate a presentation attack, such as spoofing or tampering with the biometric data of the data packages. Information that may be sufficient to enable the system to identify a spoof attack may or may not be available within a single data package or with a single image data frame. For example, in some embodiments, information that may be sufficient to enable the system to identify a spoof attack may become evident only after processing a certain number of image data frames of one or more data packages. By aggregating this information from multiple image data frames of a sequence of image data frames and/or from multiple data packages of a sequence of data packages, the detector can make more informed decisions about the legitimacy of the presented biometric data, ultimately improving the accuracy and effectiveness of presentation attack detection.

The system may be configured to output at least two types of information after processing one or more image data frames and/or one or more data packages: (a) image quality user feedback information 250iq and (b) presentation attack result information 250ir.

Image quality user feedback information 250iq may include any suitable indicator(s) of the overall quality of the captured image(s) or frame(s) of data 225, including, but not limited to, exposure level, blurriness, sensor cleanliness, presence or absence of biometric artifacts, occlusions, presence of multiple faces within a frame, and/or the like. This feedback may be intended to provide users with any suitable opportunities to assess the suitability of each frame for presentation attack detection and/or biometric recognition (e.g., a frame containing a picture of a display screen or other device used normally for spoofing can be considered good for detecting spoof attack but not good for biometric recognition, a frame containing a user not looking directly toward an image sensor can be considered good for presentation attack detection but not good for biometric recognition), and/or to allow the user to possibly change their pose, position of the sensor, lighting, and/or any other suitable aspects of the biometric sampling (e.g., by instructing the user to rotate their head pose (e.g., in the case of a facial recognition biometric) and/or to stare directly into a camera (e.g., for retinal and/or iris recognition biometric(s) and/or to adjust the distance of their body with respect to one or more image sensors and/or the like). This feedback may or may not be presented to a user after processing each frame or after processing a sequence of frames (e.g., using a display or any other suitable output component (e.g., component 160 of device 60), such as in textual, audible, and/or pictographic form), which may be configured to indicate to the user how to improve the quality of the frame(s) being captured. Examples of such feedback may include, but are not limited to, a user prompt (e.g., a visual and/or audible prompt) to “move to a brighter area” and/or to “make sure that there is only one face in the frame.” Examples of pictographic feedback may include, but are not limited to, colored lights (e.g., green, yellow, red lights of any suitable output component) that may be updated as the quality of the capture improves, or a visual icon representing a surgical mask to indicate that the user's mouth and nose are not visible. In some embodiments, certain feedback may be presented to the user, while in other embodiments, certain feedback may be configured to be automatically used by the system to automatically adjust one or more characteristics to improve the frame capture (e.g., increase the light brightness in the location that the user is standing, etc.). An integrator (e.g., integrator I of FIG. 3 (e.g., a human or a machine)) may be enabled to configure the system to use various types of feedback however the integrator may choose (e.g., by programming or otherwise configuring any suitable managed element (e.g., managed element 399 of FIG. 3 (e.g., any element(s) or component(s) of detector 350 and/or of system 301 (e.g., of a user device or APS subsystem and/or the like) that may be used to receive any suitable generated detector information 350i (e.g., data 350iq and/or data 350ir) and use that information for any suitable purpose, such as to instruct a user to manually and/or to automatically use the system to control/adjust one or more functionalities of managed element 399 (e.g., a GUI/lights/sensors of a biometric sensing device, alarms, etc.) so that the application may describe all possible tangible results that may be achieved using the processing of detector 350)) in any suitable manner).

Presentation attack result information 250ir may include, for example, any suitable information indicative of one of any suitable set of potential results or outcomes, such as a result set including, but not limited to, the following outcomes:
(i) An “indeterminate” result: This may be a result indicative of a situation where the system has not been able to collect enough information to determine whether the frame(s) portray a genuine attempt or a presentation attack. In this case, the system may indicate that additional frames or data packages may be required to make a definitive determination regarding the authenticity of the presented biometric data. The user may be prompted to supply at least one other frame to resolve the ambiguity. As shown in FIG. 2, such an “indeterminate” result 250iri of presentation attack result information 250ir may be returned in some way (e.g., to data packaging module 230 or otherwise) to initiate acquisition of one or more new frames and/or packages;
(ii) A “spoof” result: This may be a result indicative of a situation where the system has detected a deliberate attempt to manipulate the biometric data or otherwise deceive the system. In this case, the system may determine that further processing is not warranted and that the entire session may be aborted and any previously captured frames may be deemed invalid for recognition purposes (e.g., none of the biometric data of the processed packages may be used for enrollment and/or authentication purposes). The system may notify the user of this decision in any suitable manner or not at all (e.g., the system may provide a generic error message (e.g., “please try again” or “unable to verify subject liveness”) and/or may lock the user from using the system for a certain period of time and/or may add a user/device to a fraud check database and/or may act in any other suitable manner (e.g., as may be determined by an integrator (e.g., by programming or otherwise configuring any suitable managed element (e.g., managed element 399 of FIG. 3) in any suitable manner)));
(iii) A “genuine” result: This may be a result indicative of a situation where the system has detected authentic biometric data that may be further processed for user authentication purposes. In this case, the system may determine that the session is genuine and can be used to extract biometric information for recognition purposes. The user may be notified that the presented biometric data is authentic (e.g., has been determined not likely to be a presentation attack) and can be processed accordingly or the system may automatically attempt to process the biometric data for user enrollment and/or user authentication purposes and then notify the user or proceed based on the results of that attempt (e.g., “biometric recognition approved” or “biometric recognition denied”); and/or
(iv) A “rejection” result: This may be a result of some policy timeout (e.g., the session took too long without the detector being able to make a genuine/spoof decision, too much time elapsed without any biometric material being presented to a sensor (e.g., if user does not show their face for some time), and/or the like).

The system may be configured to arrive at one of these outcomes based on a multitude of factors, including, but not limited to, the quality of the input as assessed by the system, the state of the aggregator, the current frame and/or package, and the previous frame and/or package.

### FIG. 3

FIG. 3 may illustrate a detailed diagram of a system 301, which may be any suitable stateful presentation attack detector mechanism system (e.g., a system that may be the same as or similar to system 201 of FIG. 2), and which may include any suitable presentation attack detector 350 (e.g., a detector that may be the same as or similar to detector 250 of FIG. 2).

System 301 may be configured to employ a novel approach to detecting presentation attacks by combining multiple single-frame detector models and multi-frame detector models, utilizing policies to analyze the captured biometric data, and aggregating them through time. A system may be configured to aggregate the output (i.e., “predictions”) of multiple detector models. Additionally or alternatively to aggregating outputs, some processed values for the information (e.g., mean, standard deviation, and/or the like for the movement sensor data), color characteristics and histograms of the image, and/or any other suitable information may be aggregated. A single frame detector model may be configured to work on (e.g., receive as input(s)) only a single frame or data package (e.g., a model configured to detect a presence of a screen in an image). A multi-frame detector model may be configured to work on (e.g., receive as input(s)) multiple frames or data packages (e.g., a model configured to detect the movement of a face in a sequence of images vs. the movement of a background of in a sequence of images).

As one example, a classifier model may be a multiresolution classifier model (see, e.g., model 366cc), which may include any suitable number of independent models (e.g., one for detecting a paper mask in an image, one for detecting reflection of a display screen in an image, and/or the like, and/or one for detecting a spoof in an image from a first sensor of the package, one for detecting a spoof in an image from a second sensor of the same package, and/or the like) and an aggregator model that may aggregate the outputs of all the independent models.

Presentation attack detector 350 may include one or any other suitable number of detector modules, including, but not limited to, a sensor data processing detector module 352a, a depth and motion detector module 352b, a screen and presentation attack instrument (“PAI”) detector module 352c, an identity consistency detector module 352d, a quality checks detector module 352e, and/or the like. Each detector module may be configured to process a respective predefined number of image data frames of a package (e.g., multiple frames of a package in the case of depth and motion detector module 352b (e.g., previous image data frame 335fp of the current package 335 (e.g., image data frame 325bp of one or more previous image frames) and current image data frame 335fn of the current package 335 (e.g., image data frame 325bn of the most recent image frame)), one frame in the case of screen and PAI detector module 352c (e.g., current image data frame 335fn of the current package 335 (e.g., image data frame 325c of the most recent image frame, which may be the same as image data frame 325bn, image data frame 325d, and image data frame 325e)), one frame in the case of module 352d (e.g., current image data frame 335fn of the current package 335 (e.g., image data frame 325d of the most recent image frame)), and one frame in the case of module 352e (e.g., current image data frame 335fn of the current package 335 (e.g., image data frame 325e of the most recent image frame)), etc.) and/or motion data of a package (e.g., motion data 335s of the current package 335 (e.g., motion data 345a of the current package, which may be the same as motion data 345b and motion data 345d) in the case of module 352a, motion data 335s of the current package 335 (e.g., motion data 345b of the current package) in the case of module 352b, and motion data 335s of the current package 335 (e.g., motion data 345d of the current package) in the case of module 352d). Detector 350 may also include any suitable policies module 352f. Detector output data from one, some, or each of the detector modules (e.g., detector output data 375a and/or data 375ac from sensor data processing detector module 352a, detector output data 375be and/or detector output data 375bc from depth and motion detector module 352b, detector output data 375c from screen and PAI detector module 352c, detector output data 375dr and/or detector output data 375dk from identity consistency detector module 352d, detector output data 375e from quality checks detector module 352e, and/or the like) and/or policy output data 375f from policies module 352f may be received by any suitable multi-frame aggregator and policy evaluator (“A&E”) module 380 of detector 350 (e.g., a multi-frame aggregator classifier model). A&E module 380 may be configured to process any such output data 375 from any such module(s) 352 (e.g., over an unbounded number N of frames 325f of frame or image data 325 (e.g., data that may be provided by a module 320 that may be the same as or similar to module 220 of system 201 of FIG. 2 and/or data that may be provided by any suitable sensor(s) 315 that may be the same as or similar to sensor(s) 215 of system 201 of FIG. 2 and/or data that may be the same as or similar to data 225 of system 201 of FIG. 2) and/or any suitable motion data 345 (e.g., data that may be provided by a module 340 that may be the same as or similar to module 240 of system 201 of FIG. 2 and/or data that may be provided by any suitable sensor(s) 315′ that may be the same as or similar to sensor(s) 215′ of system 201 of FIG. 2 and/or data that may be the same as or similar to data 245 of system 201 of FIG. 2), where such image data frames 325 and stream(s) of motion data 345 may be gathered, buffered, synchronized, and packaged into a package in any suitable manner by any suitable data packaging module 330 that may be the same as or similar to module 230 of FIG. 2 (e.g., a package 335 including a most recent image data frame 335fn, at least one sequentially earlier image data frame 335fp, and any motion data 335s captured during a package capture timeframe of package 335)) and to generate, based on such processing, (i) any suitable user feedback information 350iq (e.g., user feedback information that may be the same as or similar to user feedback information 250iq of FIG. 2) and/or (ii) one or more computed decisions (e.g., as computed decision data 385) that may be used to generate any suitable presentation attack result information 350ir (e.g., presentation attack result information that may be the same as or similar to presentation attack result information 250ir of FIG. 2), where such generated detector information 350i (e.g., any suitable user feedback information 350iq and/or any suitable presentation attack result information 350ir) may be provided to any suitable managed element(s) 399 that may be configured to utilize such generated detector information 350i to control any suitable functionality(ies) of element 399.

Each detector in the system (e.g., each detector module 352 of detector 350 of system 301) may be configured to use one or more preprocessing modules, each of which may be configured to perform one or more suitable preprocessing operations (e.g., to prepare the data being preprocessed for use by an associated detector model, or a model may be configured with its own preprocessing functionality built-in to the model itself). Such operation(s) may vary based on the type of signals being processed. For example, one or more preprocessing operations that may be used in conjunction with one or more detector models that may process image data may include, but are not limited to, image scaling, rotation, cropping, de-noising, color normalization, luminance normalization, resizing, contrast enhancement, color space conversion, edge detection, and/or the like. As another example, one or more preprocessing operations that may be used in conjunction with one or more detector models that may process motion data may include, but are not limited to, filtering (e.g., low-pass/high-pass/band-pass filtering), noise reduction, data normalization, data segmentation, artifact removal, sensor bias correction, down sampling, wavelet compression, and/or the like. Different modules may be configured to use different combinations of normalization operations, even when processing inputs of the same type. For example, as shown, sensor data processing detector module 352a may include (i) any suitable motion data preprocessing module 362a that may be configured to receive any suitable motion data 345a (e.g., from any suitable source(s) (e.g., from any suitable sensor(s) 315′ and/or from any suitable module(s) 340)) and process such motion data 345a to generate any suitable sensor data processing detector output data 375a for A&E module 380, and (ii) any suitable spoof classifier module 366ac that may be configured to receive any processed sensor or motion data as sensor data processing detector output data 375a from module 362a and process such received processed sensor/motion data to generate any suitable classified sensor data processing detector output data 375ac for A&E module 380. Additionally or alternatively, as shown, depth and motion detector module 352b may include (i) any suitable previous frame(s) image data preprocessing module 364bp that may be configured to receive any suitable image data 325bp (e.g., from any suitable previous frame(s) 325f from any suitable source(s) (e.g., from any suitable sensor(s) 315 and/or any suitable module(s) 320)) and process such image data 325bp to generate any suitable previous frame(s) processed image data 325bp', (ii) any suitable current frame (e.g., frame n) image data preprocessing module 364bn that may be configured to receive any suitable image data 325bn (e.g., from any suitable current frame 325f) and process such image data 325bn to generate any suitable current frame processed image data 325bn′, (iii) any suitable depth and motion estimation module 366be that may be configured to receive any previous frame(s) processed image data 325bp′ from module 364bp and/or any current frame processed image data 325bn′ from module 364bn and process such received processed image data to generate any suitable depth and motion detector output data 375be for A&E module 380 and/or any suitable frame processed estimation image data 325be for further use by detector module 352b, (iv) any suitable motion data preprocessing module 362b that may be configured to receive any suitable motion data 345b (e.g., from any suitable source(s) (e.g., from any suitable sensor(s) 315′ and/or from any suitable module(s) 340)) and process such motion data 345b to generate any suitable processed motion data 345b′ for A&E module 380 (direct coupling line not shown) and/or to module 366bc, and (v) any suitable depth and motion classifier module 366bc that may be configured to receive any such frame processed estimation image data 325be from module 366be and/or any suitable motion data 345b (e.g., from any suitable source(s) (e.g., from any suitable sensor(s) 315′ and/or from any suitable module(s) 340)) and process such received image and/or motion data to generate any suitable depth and motion detector output data 375bc for A&E module 380. Additionally or alternatively, as shown, screen and PAI detector module 352c may include (i) any suitable current frame (e.g., frame n) image data preprocessing module 364c that may be configured to receive any suitable image data 325c (e.g., from any suitable current frame 325f) and process such image data 325c to generate any suitable current frame processed image data 325c′, and (ii) any suitable multiresolution spoof classifier module 366cc that may be configured to receive any current frame processed image data 325c′ from module 364c and process such received processed image data to generate any suitable screen and PAI detector output data 375c for A&E module 380. Additionally or alternatively, as shown, identity consistency detector module 352d may include (i) any suitable motion data preprocessing module 362d that may be configured to receive any suitable motion data 345d (e.g., from any suitable source(s) (e.g., from any suitable sensor(s) 315′ and/or from any suitable module(s) 340)) and process such motion data 345d to generate any suitable processed motion data 345d', (ii) any suitable current frame (e.g., frame n) image data preprocessing module 364d that may be configured to receive any suitable image data 325d (e.g., from any suitable current frame 325f) and process such image data 325d to generate any suitable current frame processed image data 325d′, (iii) any suitable biometric recognition module 366dr that may be configured to receive any processed motion data 345d′ from module 362d and/or any current frame processed image data 325d′ from module 364d and process such received processed data to generate any suitable identity consistency detector output data 375dr for A&E module 380 and/or any suitable processed recognition data 365d for further use by detector module 352d, and (iv) any suitable consistency checker module 366dk that may be configured to receive any such processed recognition data 365d from module 366dr and process such received processed recognition data 365d to generate any suitable identity consistency detector output data 375dk for A&E module 380. Additionally or alternatively, as shown, quality checks detector module 352e may include (i) any suitable current frame (e.g., frame n) image data preprocessing module 364e that may be configured to receive any suitable image data 325e (e.g., from any suitable current frame 325f) and process such image data 325e to generate any suitable current frame processed image data 325e′ and any suitable current frame processed image data 325e“, (ii) any suitable biometric presence detector module 366ed that may be configured to receive any such current frame processed image data 325e” from module 364e and process such received current frame processed image data 325e“ to generate any suitable biometric processed image data 325e”, and (iii) any suitable quality evaluation module 366eq that may be configured to receive any current frame processed image data 325e′ from module 364e and/or any biometric processed image data 325e′″ from module 366ed and process such received processed image data to generate any suitable quality checks detector output data 375e for A&E module 380. Additionally or alternatively, as shown, policies module 352f may include any suitable presentation attacks policy module 366f that may be configured to receive or otherwise access any suitable policy data 365f from any suitable data source(s) 360 and process such accessed policy data to generate any suitable policies module output data 375f for A&E module 380. Although not shown (e.g., for sake of clarity of FIG. 3), one, some, or each preprocessed image data frame of a current data package (e.g., image data frame(s) 335fp (e.g., frame(s) 325bp) of data package 335 and/or image data frame 335fn (e.g., frame 325bn, 325c, 325d, 325e) of data package 335), one, some, or each preprocessed motion data of a current data package (e.g., motion data 335s (e.g., motion data 345a, 345b, 345d) of data package 335), one, some or each processed image data frame of a current data package (e.g., processed image data frame(s) 325bp′, 325bn′, 325c′, 325d′, and/or 325e′ of data package 335), and/or one, some, or each processed motion data of a current data package (e.g., motion data 375a, 345b′, and/or 345d′ of data package 335) may be directly coupled to or otherwise provided to A&E module 380 as an additional input to A&E module 380 (e.g., input to the multi-frame aggregator classifier model of module 380) such that A&E module 380 can be enabled to process any raw and/or processed previous and/or current image frame data and/or motion data of a most recent data package and/or of any previous data package. System 301 of FIG. 3 may include detector 350, any suitable sensor(s) 315/315′ of any suitable module(s) 320/340 (e.g., as may be the same as or similar to any suitable sensor(s) 215/215′ of any suitable module(s) 220/240), any suitable module 330 (e.g., as may be the same as or similar to module 230), any suitable processor(s), any suitable memory, any suitable application(s), any suitable input/output component(s), any suitable power source(s), any suitable communication component(s), and/or the like (e.g., as may be described with respect to any suitable subsystem(s) 120).

### Sensor Data Processing

As shown in FIG. 3, sensor data processing detector module 352a of detector 350 may include (i) any suitable motion data preprocessing module 362a that may be configured to receive any suitable motion data 345a (e.g., from any suitable source(s) (e.g., from any suitable sensor(s) 315′ and/or from any suitable module(s) 340)) and process such motion data 345a to generate any suitable sensor data processing detector output data 375a for A&E module 380, and (ii) any suitable spoof classifier module 366ac that may be configured to receive any processed sensor or motion data as sensor data processing detector output data 375a from module 362a and process such received processed sensor/motion data to generate any suitable classified sensor data processing detector output data 375ac for A&E module 380. Spoof classifier 366ac may be configured to have any suitable classifiers indicative of the likelihood of any suitable concept (e.g., anything that may be useful in detecting a presentation attack) that may be derived from analysis of any suitable fast data of a package (e.g., even a package with no image data). For example, classifier 366ac may be configured to determine when data 375a is indicative of a miscorrelation of signals between different sensors 315′ (e.g., if data 345a includes first data from a first sensor 315′ (e.g., a gyroscope) of a user device indicative of a rotation about a first axis of the device and second data from a second sensor 315′ (e.g., a magnetometer) of the user device indicative of a rotation about a second axis of the device rather than the first axis, which may be indicative of a user injecting fake signals into one or both of those sensors (e.g., if fast data of a package is determined by module 352a or otherwise to be indicative of device rotation or other suitable movement (e.g., using an accelerometer or gyroscope or magnetometer sensor 315′) but image data of the package is determined by module 352b or otherwise to be indicative of no device rotation or other movement, then the detector may be configured to detect a presentation attack (e.g., an attacker may be injecting digital image data without using the device's actual camera lens), or if fast data of a package is determined by module 352a or otherwise to be indicative of a first environmental brightness (e.g., using data 345 from an ALS sensor 315′) but image data of the package is determined by module 352b or otherwise to be indicative of a much different second environmental brightness (e.g., using data 325 from a camera sensor 315), then the detector may be configured to detect a presentation attack (e.g., an attacker may be injecting digital image data without using the device's actual camera lens)). As another example, fast data 345a may be provided by a Wi-Fi communications component 315′, a Bluetooth communications component 315′, a microphone/speaker transducer 315, and/or the like of a user device 60 and may be used by classifier 366ac to determine the likelihood of the shape of an object positioned in front of a camera sensor 315 of that device (e.g., wireless communication signals may be emitted and detected by such a communications component and/or audio signals may be emitted and detected by such a transducer and a comparison of the emitted signal(s) to the detected signal(s) may be utilized to determine the presence of and/or the shape of an object positioned nearby (e.g., a flat object vs. a round object vs. no object), which may be useful to determine a presentation attack. Sensor data processing detector module 352a may be configured to perform any suitable sensor data processing to further enhance the accuracy of system 301. For example, the time between two image data frames may vary, and thus motion sensors could produce variable number of instances of motion data for such image data frames. Therefore, such variable instances of motion data may be processed in any suitable manner(s) (e.g., resampled) to a consistent amount in order to be processed more easily by any model(s) (e.g., machine learning neural network(s)) of the system (e.g., model 366ac) that may have a fixed number of inputs. This may include processing on any suitable sensor data 345 (e.g., data 345a) that may be provided by any suitable sensor data source(s), including, but not limited to, sensor(s) from an inertial measurement unit (“IMU”), such as a gyroscope and/or accelerometer, and/or a magnetometer sensor, and/or an ambient light sensor, and/or the like (e.g., one or more sensor(s) 315′). Such data 345 may be utilized (e.g., by detector module 352a and/or module 352b and/or module 352d and/or the like) to provide one or more additional information streams that can be processed and presented to A&E module 380. By incorporating such sensor data (e.g., such motion data) into the aggregation process, the performance of system 301 can be increased. Such motion sensor data can be collected continuously or periodically or otherwise, starting during image frame capture or before image frame capture (e.g., capture of any suitable data 325 for use by system 301) as may be enabled by the generation of data package 335. Matching between motion sensor data 345 and one or more frames 325f of image data 325 may be performed by data packaging module 330, which may be a specific module of system 301 and may be provided on-board and/or by detector module 350 and/or may be provided by an external integrator. The number of frames 325f of image data 325 in a data package (e.g., data package 335) can be fixed or can be unbounded (e.g., the number of image data frames 325f (e.g., of data 325bp of data package 335) sequentially previous to most recent image data frame 325f (e.g., of data 325bn of data package 335) may be any suitable number defined in any suitable way (e.g., no more than 5 sequentially previous from the most recent, the last 5 (e.g., bounded), all previous from the current session (e.g., unbounded), etc.).

Additionally or alternatively, in some embodiments, A&E module 380 may be used to generate an average of all inputs 375 for the current package, or the statefulness of A&E module 380 may be used to generate an average of new current frame and average that with previous frame (e.g., a running average but bounded on 2 packages), or do moving average for last 4 packages, or all packages averaged for a particular session (e.g., may configure so no output until at least 5 packages processed), and/or the like (e.g., as may be based on how an integrator or otherwise may program the system. Furthermore, as may be appreciated with respect to module 352b, such a module 352b may be configured to work on multiple packages and/or, with respect to model 352d, model 366dk may be configured to work on multiple packages (e.g., using memory (e.g., model 366dk may be stateful), either memory local to model 366dk or via feedback from memory of A&E module 380, or at least a portion of model 366dk may be provided by A&E module 380), while, in some embodiments, one, some, or each detector model may have memory to work in a more complex way but model 366dk is a specific example, and/or A& E module 380 may not have memory or be stateful in some embodiments if the system were configured to process just a current package data 375, and/or model 366dk may receive something similar to data 325bp so no memory (e.g., a synch buffer or packaging module 330 may usually or always have memory for packaging). For example, A&E module 380 may be configured to utilize any suitable depth and motion information data, such as detector output data 375be and/or detector output data 375bc that may be generated by depth and motion detector module 352b, in combination with any suitable sensor information that may be collected between two frames used for motion detection to identify any inconsistencies or anomalies that may not be apparent from a single data source (e.g., a single image data source 315). For example, there may be some presentation attacks that cannot be determined just with data from a single image data source (e.g., if user uses its own manipulated camera, other sensor data (e.g., motion data 345) and/or other image data may be used by the system to confirm and/or deny the camera data as genuine). If the detector were only provided with a single image data frame, motion may not be detected from the image data and correlated with any motion data.

Motion sensor data (e.g., any suitable data 345) may or may not be used as an additional information source by other components, such as depth and motion module(s) (e.g., data 345b by module 352b), identity consistency detection module(s) (e.g., data 345d by module 352d), and/or others.

### Depth and Motion Estimation

As shown in FIG. 3, depth and motion detector module 352b of detector 350 may include (i) any suitable previous frame(s) image data preprocessing module 364bp that may be configured to receive any suitable image data 325bp (e.g., from any suitable previous frame(s) 325f from any suitable source(s) (e.g., from any suitable sensor(s) 315 and/or any suitable module(s) 320)) and process such image data 325bp to generate any suitable previous frame(s) processed image data 325bp′, (ii) any suitable current frame (e.g., frame n) image data preprocessing module 364bn that may be configured to receive any suitable image data 325bn (e.g., from any suitable current frame 325f from any suitable source(s) (e.g., from any suitable sensor(s) 315 and/or any suitable module(s) 320)) and process such image data 325bn to generate any suitable current frame processed image data 325bn′, (iii) any suitable depth and motion estimation module 366be that may be configured to receive any previous frame(s) processed image data 325bp′ from module 364bp and/or any current frame processed image data 325bn′ from module 364bn and process such received processed image data to generate any suitable depth and motion detector output data 375be for A&E module 380 and/or any suitable frame processed estimation image data 325be for further use by detector module 352b, (iv) any suitable motion data preprocessing module 362b that may be configured to receive any suitable motion data 345b (e.g., from any suitable source(s) (e.g., from any suitable sensor(s) 315′ and/or from any suitable module(s) 340)) and process such motion data 345 b to generate any suitable processed motion data 345b′ for A&E module 380 (direct coupling line not shown) and/or to module 366bc, and (v) any suitable depth and motion classifier module 366bc that may be configured to receive any such frame processed estimation image data 325be from module 366be and/or any current frame processed image data 325bn′ from module 364bn and/or any suitable motion data 345b/processed motion data 345b′ (e.g., from any suitable source(s) (e.g., from any suitable sensor(s) 315′ and/or from any suitable module(s) 340)) and process such received image and/or motion data to generate any suitable depth and motion detector output data 375bc for A&E module 380. Depth and motion detector module 352b may be configured to utilize multiple frames to estimate any suitable estimated depth information (e.g., data 375be) about the frames (e.g., the frame(s) of data 325bp and the frame of data 325bn) and then apply a classifier using module 366bc based on that estimated depth information (e.g., received as an input 325be at module 366bc) and based on any suitable motion data (e.g., data 345b (e.g., processed motion data 345b′)) to determine whether the presented biometric data of the frames is genuine or a spoof attempt. For example, motion classifier module 366bc may include at least one classifier model that may be configured to use input(s) 366be and/or 345b′ to generate an output 375bc that may be indicative of the probability of spoof (e.g., a single real number) or of the probability for each spoof type (e.g., multiple real numbers (e.g., one for each attack type)) (e.g., the result of the “classifier”). In some embodiments, modules 364bp and 364bn may be the same or they could be different (e.g., one scaled down from the other, where model(s) of module 366be may have to correlate different types of input data from the different frame data). Alternatively, module 366be may be configured to be stateful such that there may be no need for previous image frame data 325bp to be provided with new image frame data 325bn to module 366be by a particular package, but instead data 325bn/325bn′ may be provided to module 366be by a new package and such data from one or more previous packages may be stored in or otherwise accessible at and used by module 366be along with the data from the new package as inputs for generating an output (e.g., possibly identical or substantially similar outputs 375be/325be) for that new package.

Module 366be may be configured to utilize any suitable current image frame data 325bn and any suitable previous image frame data 325bp to generate output data 375be/325be that may include a depth map and a motion map for the current package. A depth map may include data indicative of an estimated distance of each pixel of the current image frame from its camera (e.g., sensor 315), while a motion map may include data indicative of an estimated motion (e.g., each of an X-and Y-motion, or just a general single motion, or a direction and amount of movement, etc.) of each pixel of the current image frame. This may be achieved in various ways. As just one example, if image frame data 325 of the package(s) includes data from only one image sensor 315 (e.g., only one camera) and the camera moves between frames of a package, module 366be may be configured to detect depth using a single model or multiple models. As just one other example, if image frame data 325 of the package(s) includes data from two or more one image sensors 315 (e.g., two different cameras, each of which generate image frame data of each of image frame data 325bp and 325bn), module 366be may include at least two models to determine depth (e.g., one for each camera) or six models (e.g., one model for each of the R, G, and B values from each camera). For example, any suitable configuration may be possible (e.g., for depth estimation, module 366be may be configured to process all received image frame data and utilize one or more neural networks to determine how to combine the data for generating a useful depth map, and/or module 366be may include any suitable coded depth determining software using a depth map to determine motion information from the depth map). Module 366be may be configured in any suitable manner to extract depth and motion maps from one or more packages, each of which may be indicative of previous and current image frame data from one or more image sensors. In some embodiments, at least some image frame data of a package may be provided by a laser sensor (e.g., LIDAR) that may be configured to provide actual depth information (e.g., image data indicative of a distance of each pixel of an image from the sensor), which may be used as an input to a model of module 366be (e.g., during training of the model and/or during use of the model for generating output data for a particular package during a session of a user). In some embodiments, module 366be may be configured to include a single model that may generate an output indicative of depth and motion (e.g., slower moving parts in background and faster moving parts in foreground, such that depth and motion may be closely tied together, etc.).

Any suitable combination of any suitable slow data (e.g., image frame data) and any suitable fast data (e.g., motion data) of a package may be provided by any suitable sensors (e.g., one camera 315 and one gyroscope 315′, three cameras 315 and one gyroscope 315′ and one microphone 315′, etc.), whereby module 366be may receive and process all the slow data from a current frame and from one or more previous frames of a package to generate outputs 375be for module 380 and output 325be for module 366bc (e.g., each of which may include a depth map and a motion map (e.g., for the current frame/package)) and whereby module 366bc may receive and process output 325be along with any/all the fast data of the package to generate data 375bc for module 380. For example, module 366bc may include at least one classifier model that may generate output data 375bc as a classifier of whether the system is being spoofed or not (e.g., an output indicative of a real number between 0 and 100 where 0 may be indicative of a ~0% likelihood of an attack while 100 may be indicative of a ~100% likelihood of an attack, or an output indicative of multiple numbers where each of which may be indicative of a percent likelihood of a specific type of attack (e.g., 80% likelihood of no attack, 10% likelihood of a screen photograph attack, 5% likelihood of a screen video attack, 3% likelihood of a two-dimensional printed material attack, 1% likelihood of a three-dimensional mask attack, and 1% likelihood of all other types of attack, etc.), etc.). In some embodiments, module 366bc may include a first one of such a classifier module that may generate a first instance of such output data 375bc using depth map data of received data 325be and any environment/movement data of received data 345b/345b′ as well as a second one of such a classifier module that may generate a second instance of such output data 375bc using motion map data of received data 325be and any environment/movement data of received data 345b345b′. An exemplary classifier model of module 366bc may have a large domain of potential inputs and be classified to a small amount (e.g., 5) possible classes for its output (e.g., a probability output for each class (e.g., probability distribution across fixed number of classes (e.g., “80, 5, 5, 6, 4″ or ”100, 0, 0, 0, 0″))). In some embodiments, each one of module 366 be and module 366bc may include one or more trained neural networks. Motion estimation of module 366be may be configured to use an optical flow or a neural network that may be configured to estimate optical flow to create a motion map or a neural network that may be configured to output a map and a classifier. In some embodiments, the entirety of module 352b (or in fact the entirety of detector 350) may be provided as a single large neural network or model (e.g., mesh model), but the distinct modules and models described herein may be considered in some embodiments as more informative and/or exemplary for defining particular functions.

A depth estimation process (e.g., a process of module 366be) may involve combining any suitable information from the at least two frames (e.g., the frame of data 325bn and the frame(s) of data 325bp) using any suitable techniques, including, but not limited to, optical flow, stereo matching, and/or other suitable methods that may calculate the disparity between the two or more images (e.g., image data 325bn of a current frame and image data 325bp from one or more previous frames may feed one or more models of module 366be, whereby the more image data used (e.g., the more previous frames used) the more processing may be used (e.g., more energy, resources, size, time, etc.) but more accuracy may be realized). This may allow system 301 to generate a depth map that may represent the distance of objects in the scene (e.g., the scene of data 325bp and data 325bn of a current package) from the camera(s) and/or other suitable frame detector(s) 315 of module 320. Additionally or alternatively, this may allow system 301 to generate a motion map that may indicate how different objects in the scene move across sequential (e.g., consecutive or non-consecutive) frames.

The estimated depth map (e.g., estimated depth image) and/or the estimated motion map may then be used as input for depth and motion classifier module 366bc, which may be configured to analyze the depth and/or motion information to detect any potential presentation attacks and generate any suitable classifier(s) for the same (e.g., as detector output data 375bc). Any classifier model(s) or otherwise of module 366bc (e.g., one model or multiple models coupled to one bigger ensemble that can produce any suitable outputs to be consumed by A&E module 380) can be trained using any suitable labeled data (e.g., using data collected from the same types of sensors 315/315′ and packages of module 330 and given various genuine and spoof scenarios during such data collection). Various spoof scenarios and genuine performance of the same may be carried out during different iterations of training data collection, including, but not limited to, any suitable fingerprint spoof (e.g., paper printout or direct use of latent fingerprint on the scanner (e.g., using a latent fingerprint on the device (e.g., using print of unwilling subject)), fingerprints made from artificial materials such as gelatin or silicon (e.g., using a latent print or stolen fingerprint image), three-dimensional printed spoofs (e.g., using three-dimensional fingerprint information from a subject), etc.), any suitable face spoof (e.g., paper printout of face image or mobile device display of face photo (e.g., using a photo from social media), paper masks or video display of face (e.g., with movement and blinking) (e.g., using a high quality photo or video of a subject), silicon masks or theatrical masks (e.g., using a high quality photo or three-dimensional face information from a subject), actual subject's face (e.g., living but asleep or dead), etc.), any suitable iris/retina/eye spoof (e.g., paper printout of face image or mobile device display of face photo (e.g., using a photo from social media), video display of an iris (e.g., with movement and blinking) or printed iris with contact lens or doll eye (e.g., using video or high quality photo of subject), contact lens/prosthetic eye with a specific pattern (e.g., using high quality photo in near IR), etc.), any suitable voice spoof (e.g., replay of audio recording (e.g., using recording of voice of subject), replay of audio recording of specific pass phrase or voice mimicry (e.g., using recording of voice of specific phrase, high quality recording), voice synthesizer (e.g., using multiple recordings of voice to train synthesizer), etc.), various occlusions (e.g., where a genuine user is wearing a scarf, mask, glasses, etc.), various liveness spoofs or genuine liveness performances (e.g., active liveness where subject required to do something (e.g., blink, say key word, move head, etc.), passive liveness (e.g., just stare at screen), hybrid liveness (e.g., show text on screen to be read live or shine light on subject to see how reflection exists or instruct user to put face in a circle presented on a UI so user must move with respect to camera), and/or the like). Different screens that may be used as an attack instrument (e.g., television, tablet, etc.) may have different pixel density, refresh rate, and/or any other suitable characteristics that may vary, and different training data sets may be used for each, as may be true for printed paper or other print media (e.g., glossy reflection, black and white, color, physical artifacts, etc.), different mask materials, masks with or without holes for a live attacker to align their own eyes with, digital injection into a digital sensor of a device, and/or the like. Different models may be used for different approaches, or a single model may be trained on two or more or all approaches, where a model may be configured to search for patterns and correlate to desired results. Any classifier model(s) or otherwise of module 366bc can employ any suitable machine learning algorithms, including, but not limited to, Neural Networks, Support Vector Machines, Naive Bayes Classifiers, Random Forests, and/or the like. The output of the classifier or module 366bc may be configured to include a probability value that may be indicative of the classifier's confidence that the two most recent frames or most recent frame or most recent package correspond(s) to a presentation attack, and/or may include one or more discrete value(s) indicating one or more classes, including, but not limited to, “genuine”, “spoof”, and “indeterminate” (e.g., one integer number (e.g., 0=spoof, 1=indeterminate, 2=genuine, etc.), one real number interpreted as probability (e.g., 0.0—almost certain for spoof, 0.5—not sure whether spoof or genuine, 1.0—almost certain for genuine, etc.), multiple text strings describing genuine/type of attack (e.g., “genuine”, “photo_attack”, “print_attack”, “mask_attack”, etc.), an array of real numbers with each value corresponding to probability of a specific attack (e.g., [0.1, 0.3, 0.5, 0.05, 0.05], etc.), and/or the like). The classifier may or may not take additional sensor data input (e.g., data 345b), such as data from any suitable sensor(s) (e.g., sensor(s) 315′), including, but not limited to, accelerometer(s), gyroscope(s), magnetometer(s), and/or the like. For example, sometimes a system does not have all the motion/environment sensors available to it, however often the more data provided to the system the better the accuracy of the classification may be. In some embodiments, there may be one classifier that is trained to work with and without data 345b, or there may be multiple classifiers for each possible combination of available sensors 315′ and a system to ensemble the result. Additionally or alternatively, A& E module 380 may be configured to include multiple components (e.g., one for each possible scenario), or detector 350 may be configured as one big monolithic system that may be configured to handle all scenarios. Classifier module 366bc may or may not use this motion data in order to make its classification output data 375bc more accurate. For example, classifier module 366bc may be configured to correlate the device movement estimated using module 340 (e.g., using data 345b) with the movement estimated using module 320 (e.g., using data 325bp and/or data 325bn (e.g., video stream from the camera frames)). The output of a classifier (e.g., data 375bc output by classifier module 366bc) as well as the output of a depth and motion estimator (e.g., data 375be output by estimator module 366be) may be provided to a multi-frame aggregator (e.g., A&E module 380), which may be configured to use this information to update its internal state and potentially output a decision. In some embodiments, classifier module 366bc may be configured to receive as input data 325bn′ (e.g., actual image data and not just the map data 325be), which may be useful in enabling module 366bc to analyze the image and determine whether or not motion information may be useful for the image. This may help the classifier to make better decisions on image data and not just on motion and depth data.

By analyzing the estimated depth information and/or the output of the depth and motion classifier, the system may be configured to provide an additional technique to detect presentation attacks that may not be apparent from other biometric features or detection methods, such as print or screen photo attacks. An exemplary scenario may be a print attack, where an attacker prints a high quality photograph of a subject's face on high quality paper and presents it to the detector during a biometric session. With presentation of such a photograph, the face movement and the background movement is the same as both the face and background are printed on the photograph. In a live situation, the background is usually moving slower compared to the face, as it is farther away from the camera. Thus this movement information can be used to estimate the depth of the scene and thus detect the print attack with higher confidence. Another example may be an “injection” attack, where the attacker is injecting a fake video feed to the device to simulate fake identity. In such a situation, the motion estimation from the camera frames may be correlated with the motion information from the device itself. If the movement of the device (e.g., as may be identified via any suitable motion data 345) does not match the movement estimated from the video frames, this injection attack can be detected with higher confidence.

### Screen and Presentation Attack Instruments Detection

As shown in FIG. 3, screen and PAI detector module 352c of detector 350 may include (i) any suitable current frame (e.g., frame n) image data preprocessing module 364c that may be configured to receive any suitable image data 325c (e.g., from any suitable current frame 325f) and process such image data 325c to generate any suitable current frame processed image data 325 c', and (ii) any suitable multiresolution spoof classifier module 366cc that may be configured to receive any current frame processed image data 325c′ from module 364c and process such received processed image data to generate any suitable screen and PAI detector output data 375c for A&E module 380. Screen and PAI detector module 352c may be configured to utilize any suitable number and type(s) of classifiers that may be trained on any suitable number and type(s) of different resolutions to identify and detect screen-based presentation attacks and/or attacks using any other suitable instruments, including, but not limited to, masks, cutouts, and 3D-printed faces. Module 352c (e.g., module 366c) may just be processing current image frame data (e.g., data 325c, which may be the same as data 325bn) of the current package, and may be configured to extract data from that image frame data (e.g., is a screen and/or another spoof instrument visible in the image?). Module 366c may include one or multiple models (e.g., machine learning models) and/or algorithm(s) (e.g., one or more decision trees, not necessarily machine learning) to look at different resolutions (e.g., one for far away faces, one for closer faces, one to detect screens, etc.), which can be a mixture of expert models/classifiers or one big classifier (e.g., depending on implementation). While some embodiments described herein may focus on biometrics of a user's face, a system or presentation attack detector may be used for any suitable type of biometric image data (e.g., finger, face, eye, (e.g., with any suitable sensor(s) 315 (e.g., specialized cameras/sensors (e.g., wet sensors and/or periocular region sensors, etc.), voice biometrics (e.g., where image frame data 325 may be images of a user's lips and/or other facial expressions while the actual voice may be captured as fast data 345), gait/typing/motion biometrics (e.g., some or most or all of this may be detected using fast data, except perhaps images of fingers typing, although may more often include comparing sounds and touches of a keyboard with software input of glyphs), while other fast signals, such as wireless communication strength of device (e.g., WiFi and/or Bluetooth) strength may be used to estimate what object(s) may be positioned adjacent the device (e.g., device may send high frequency inaudible sound(s) from a speaker and detect how it arrives at a microphone and from this can be configured to estimate if something is in front of a screen that may be flat or not flat thereby using audio to estimate depth), whereby fast data may be any suitable data that can be sensed by the device, including wireless communication strength and/or interference (e.g., if a camera image data indicates that a face is close to a screen but wireless signals and/or audio analysis indicates otherwise, then spoof may be more likely). Generally, a screen-based attack of interest by module 352c may be any attack where fake biometric material (e.g., a spoof) may be presented on a computer screen and positioned as if it was actual live biometric material. Module 352c may additionally or alternatively be configured to detect any other suitable non-screen display instruments, including, but not limited to, paper prints, cutout masks, silicon masks, three-dimensional printed heads, and/or the like.

Module 352 c (e.g., module 364 c and/or module 366cc) may be configured to analyze the captured biometric data of current image frame data 325c of the current package for patterns or artifacts that may be indicative of an instrument-based attack. For example, module 352c may include one classifier or multiple different classifiers (e.g., classifier models), where each may be trained and optimized for a specific resolution or image quality level, to recognize characteristic features or anomalies in the presented biometric data. Each classifier may be trained using any suitable data (e.g., any suitable labeled data) and can employ any suitable machine learning algorithms, including, but not limited to, Deep Neural Networks, Support Vector Machines, Random Forests, and/or the like.

In some embodiments, different classifiers can be trained using different respective sets of labeled data, such as different sets of data with different respective resolutions and cropped sub-images, including, but not limited to, low-resolution images (e.g., 128×128 pixels), medium-resolution images (e.g., 256×256 pixels), high-resolution images (e.g., 512×512 pixels or larger), and/or the like. For example, different models may be trained on differently preprocessed inputs. For example, from one image of data 325c, the system may be configured to crop regions of various size around a detected face, and thus create multiple new images, whereby each new image may go to a different classifier. Additionally or alternatively, each attack type (e.g., screen photo, screen video, print photo, three-dimensional mask, etc.) can have its own “expert” classifier that may be trained just to detect this type of attack and nothing else.

Additionally, these may be combined to create families of classifiers, where each family may include multiple expert classifiers, each of which may be working on a different crop size and/or the like. For example, expert classifiers may be in parallel to other classifiers (e.g., a classifier that may be specifically trained to detect a particular attack instrument with yes or no output or probability of yes/no, such that each model may be configured to provide a probability output for its expertise, then all those may be provided to a coordination or ensemble model that may be configured (e.g., trained and/or otherwise programmed) to provide a single output based on the inputs (e.g., the outputs from the expert models). Such an ensemble model may be provided by module 366c and may provide output 375c (e.g., as a single probability or list of probabilities or two-dimensional area of probability (e.g., classifiers in different rows and columns for each attack type so a matrix of probabilities)). Alternatively, such an ensemble model may be provided by A&E module 380, whereby output 375c of module 352c may be the outputs of all the expertise models. Alternatively, such an ensemble model may be provided by module 366c, whereby output 375c can be both an ensemble output (e.g., matrix) and each one of the expertise model outputs, such that A&E module 380 can access all such data. If such an ensemble module may be provided by A& E module 380, it may use time to ensemble expertise model outputs from multiple frames (e.g., as may be stored memory of information from frames), as A&E module 380 may be stateful. Each classifier may be configured to recognize specific patterns or artifacts that may be indicative of a screen-or other suitable instrument-based attack, including, but not limited to, interference patterns (e.g., subtle changes in the image that may suggest a screen-based attack (e.g., inconsistencies in pixel values or texture)), screen artifacts (e.g., visible features or anomalies in the image that may indicate a screen-or other suitable instrument-based attack (e.g., visible part of screens or other devices, pixels, or other visual cues for presentation attack instruments)). An output 375c of module 352c may be a recognized pattern/artifact of a specific classifier of module 352c for a specific image of data 325c or output 375c of module 352c may be all recognized patterns/artifacts of all classifiers of module 352c for a specific image of data 325c. All such combinations may be viable. One option may be to aggregate all subclassifier results into one number and feed that into A&E module 380. Another approach may be to put individual results of each expert classifier into an array of tens or hundreds of numbers and feed the whole array to A&E module 380.

By analyzing the captured biometric data using multiple classifiers trained on different resolutions, the system may provide an effective mechanism to detect and prevent screen-and/or any other suitable instrument-based presentation attacks. This approach can help improve the overall accuracy and robustness of the presentation attack detection system. Output 375c may be indicative of detected likelihood of each kind of presentation attack instrument from the image data (e.g., mobile phone with an image of the face, or user interface of a video player visible on the screen, or specific holes around the eyes of cutout masks, etc.). Without module 325c, many of these attacks may be undetectable. Depth and motion module 352b may not be configured to keep details of each image but instead only depth and motion information of specific parts, while module 352c may be useful to easily to create models by only training on image data (e.g., where there may be much more training data, cheaper training data than some training data of smaller and more precise data sets for module 352b), which may allow for different training costs for different models/modules. In some embodiments, classifier 366cc might also receive as input any suitable fast data (e.g., data 335s/345a), such as ALS sensor data, microphone sensor data, GPS sensor location data, and/or the like to better enable spoof detection, or this may be done by A&E module 380. In such embodiments, the system may be configured to detect discrepancies between a condition identified in the image data and a condition identified in the fast data for increasing the likelihood of one or more types of presentation attack (e.g., detecting an outdoor object in an image (e.g., sun, moon, stars, clouds, ocean, trees, etc.) while detecting an indoor environment from the associated fast data (e.g., GPS location data, etc.) or while detecting other conflicting environment information from the associated fast data (e.g., weather data, temperature data, location data, clock data, microphone data, and/or the like indicating a different environment than the image data (e.g., night vs. day, sunny vs. rainy, outside vs. inside, loud environment (e.g., bar, airport, etc.) vs. quiet environment, etc.)), detecting a first brightness level in an image while detecting a different brightness level from the associated fast data (e.g., ALS data, etc.), and/or the like).

### Identity Consistency Detection

As shown in FIG. 3, identity consistency detector module 352d of detector 350 may include (i) any suitable motion data preprocessing module 362d that may be configured to receive any suitable motion data 345d (e.g., from any suitable source(s) (e.g., from any suitable sensor(s) 315′ and/or from any suitable module(s) 340)) and process such motion data 345d to generate any suitable processed motion data 345d′, (ii) any suitable current frame (e.g., frame n) image data preprocessing module 364d that may be configured to receive any suitable image data 325d (e.g., from any suitable current frame 325f) and process such image data 325d to generate any suitable current frame processed image data 325d', (iii) any suitable biometric recognition module 366dr that may be configured to receive any processed motion data 345d′ from module 362d and/or any current frame processed image data 325d′ from module 364d and process such received processed data to generate any suitable identity consistency detector output data 375dr for A&E module 380 and/or any suitable processed recognition data 365d for further use by detector module 352d, and (iv) any suitable consistency checker module 366dk that may be configured to receive any such processed recognition data 365d from module 366dr and process such received processed recognition data 365d to generate any suitable identity consistency detector output data 375dk for A&E module 380. Module 352d may be configured to generate vectors to be used for one or more enrollment biometric templates and/or authentication biometric samples, and/or they may be regenerated with the same or a more precise module after determining no spoof with detector 350 (e.g., the system may include a smaller or faster identity consistency detection module for presentation attack detection and then a larger or more robust one for EBT/ABS creation and/or comparison (e.g., when the system may have more time and doesn't need to worry about delaying the spoof check). However, the same biometric data that may be used by detector 250 may be later used for biometric authentication. Identity consistency detector module 352d may be configured to run any suitable biometric recognition model(s) (e.g., one or more models of biometric recognition module 366dr) for each valid frame of image frame data 325d of a current package captured during a biometric session to extract the corresponding identity associated with that frame (e.g., if frame has biometric material such that identity can be extracted). The setup can be varied here and still fulfill the same goal with the same accuracy. A classifier model (e.g., model 366dk) may be configured to accept input data and assign them to one or more specified classes (e.g., attack types, etc.) with some probability, while a recognition model (e.g., model 366dr) may be configured to produce some identity information (e.g., a list of 128 numbers) that may be very similar for one person, but very different across different people. Any suitable biometric presence detector module (e.g., module 366ed of module 352e) may also be used by or another instance thereof may be provided by biometric recognition module 366dr of module 352d (e.g., to detect biometric presence before attempting to detect any biometric recognition). Module 366dr may be configured to extract some kind of identity information from a single image frame (e.g., image frame data 325d) and any motion data (e.g., motion data 324d) of a current package, where output 375dr/365d may be configured to provide a list of numbers that may be very consistent for a particular user regardless of current situation (e.g., current lighting, facial hair, head covering(s), etc.) and may be based, for example, on the distance between a user's eyes and nose, and/or the like (e.g., module 366dr may include a recognition model (e.g., a neural network) that may be configured to generate any suitable number that may be invariant to image conditions for a particular user and/or a classifier using a database of known users where each may be a class for a classifier. Consistency checker module 366dk may be provided with memory in order to compare current image frame data to data extracted from previous image frames (e.g., identities detected, etc.) or module 366dk can be stateless if receiving previous frame data at same time from module 330 similarly to module 352b or back from A&E module 380, which may be less effective than stateful for looking at identities over longer periods of time (e.g., over more instances of image frames). Module 366dk may be configured to check for consistency between a current image data frame and any previous image data frame(s) to determine if they are consistent enough or not. Module 366dk may not be configured to detect any particular type of presentation attack (e.g., a mask, etc.) but instead may be configured to determine if any detected biometric identity is changing over time and by how much (e.g., if changing too much (e.g., attacker switches between their face and that of a victim) or too little (e.g., attacker using static printout or hijacked the camera and injected an image) it may be indicative of a spoof) and provide output 375dk, such that module 366dk may be useful to determine what level of consistency exists during the session, which may enable A&E module 380 to be provided with as much useful information as possible (e.g., via data 375dk). Therefore, output data 375dr from module 366dr may provide A&E module 380 (and module 366dk) with a specific frame's biometric identity, while output data 375dk from module 366dk may provide A&E module 380 with a classifier of a probability of consistency (e.g., level of consistency, spoof classifier), where a first type of output of output data 375dk may be a level/probability/amount of consistency over any amount of frames including the current frame while a second type of output of output data 375dk may be a spoof probability. The resulting stream of identities from module 366dr may be received and stored and/or aggregated by module 366dk (e.g., as data 365d) that may be configured to check if the identities match some similarity threshold(s), which can be configured to achieve a specific ratio of false accepts/false rejects and/or the like. Then the identity stream (e.g., data 365d) may be evaluated by module 352d (e.g., by any suitable consistency checker 366dk) to detect any suitable changes in identity that may occur during the session (e.g., any suitable changes in identity between different (e.g., sequential if not consecutive) identities in the stream) and generate any suitable output (e.g., data 375dk) that may be indicative of such detection. For example, for any evaluated pair of any two suitable identities, the system may be configured to generate any suitable detector output data (e.g., data 375dk) that may be indicative of any suitable change detection decision, including, but not limited to, a binary change detection decision (e.g., a decision that may be indicative of a “match” or “no-match”) or a value change detection decision (e.g., a decision that may be indicative of a confidence of the system that the two identities match (e.g., a confidence value between 1 and 100)). Module 366dk may be configured to check whether a biometric identity changed during the session (e.g., to determine if an attacker achieved liveness then switched to a photo of a victim), such that module 366dk may determine if the recognized biometric identity of various frames of a session appropriately correlate to one another (e.g., all of them or at least some of them or just the last one with a previous one or some other mix of approaches).

Output 375dk of such a module 366dk may be either binary or a confidence or both. This detection capability may provide utility to one or multiple parts of the system.

As an example, a policy mechanism of the system (e.g., module 352f) may be configured to use this information to make any suitable decision(s) based on the detected identity consistency or inconsistency. Policies (e.g., as may be defined by data 365f of any suitable data source 360) may be defined in any suitable manner(s) (e.g., by administrator A or otherwise) that may be operative to affect various ones of modules 352a-352e and 380 or just module 380 (e.g., via data 375f). Each one of such modules may be configurable by a multitude of parameters, which may depend on the underlying mechanism/machine learning model that may be chosen to implement one or more portion(s) of the modules. The way policies are used and implemented can vary a lot and still achieve the same effect. Policy settings may be fed to A&E module 380 together with consistency check results of data 375dk, and a final decision of the detector may be made by A&E module 380. However, in other embodiments, it may additionally or alternatively be viable for these settings to come from a different place (e.g., straight to module 352d or module 366dk and have the decision made there). In the end, what may matter is that identity consistency may be checked somewhere in detector 350 to detect whether or not the biometric material subject has changed during the session. In some embodiments, examples of policies that may be used by the system to output a “spoof” decision (e.g., result 350irs) may include, but are not limited to, when the binary decision over two consecutive identities is a “no-match”, when a policy is implemented that defines two thresholds t₁ and t₂ such that t₁<t₂ (e.g., if the confidence that the identity of the user across any two frames in the session is below t₁, then the system may be configured to output “spoof”, and if the confidence that the identity of the user across any two frames in the session is between t₁ and t₂ for more than a predefined percentage or number of frames, then the system may be configured to output “spoof”, etc. (e.g., such thresholds and/or rules may be defined in various ways depending on the specific implementation or machine learning model being used, and may be tuned based on that (e.g., it may be one real number that says how “far away” the identities can be to be still considered the same subject))), when a certain ratio of frames from the stream has identity no-match to other frames (e.g., this may be tuned based on some data that was gathered previously while using and/or developing the system (e.g., this may be either from deployment or from data collection activity, etc., where a desired tradeoff between false accept rate and false reject rate may be tuned based in any suitable ways, such as differently for each customer or integrator)), when a new frame identity is too far from the aggregation of the previously extracted identities from the stream so far (e.g., there may be various policies and approaches to take here that may all achieve very similar effect (e.g., to detect person change), which can depend on implementation (e.g., if the detector is used with a kiosk in a store, there may always be lots of people in background and other identities may be detected, so if only one or two frames, the system may be tuned not to care, whereas a scenario validating a worker and no background expected, the system thresholds can be tweaked or decision making can be tweaked (e.g., with A&E module 380 or otherwise))

As another example, A&E module 380 may receive such detector output data 375dk from consistency checker module 366dk of identity consistency detection module 352d and process such data alone and/or in combination with any other suitable data (e.g., data 375a, 375be, 375bc, 375c, 375dr, 375e, and/or 375f) to generate any suitable output(s) (e.g., user feedback information 350iq (e.g., user feedback information that may be the same as or similar to user feedback information 250iq of FIG. 2) and/or (ii) one or more computed decisions (e.g., as computed decision data 385 (e.g., as one of results 350irs, 350irg, 350irr, and 350iri of presentation attack result information 350ir (e.g., via any suitable result postprocessing module 390)))). In some embodiments module 380 and module 390 may be a single module. In some embodiments, A&E module 380 may be implemented as a machine learning system that may be configured to output probabilities (e.g., as output 385), and then by postprocessing on those probabilities to obtain specific finite decisions. However, this may vary based on the implementation. Therefore, in some embodiments, the output of the identity consistency detector may not, on its own, lead to a “spoof” decision, but may be consumed by the multi-frame aggregator in order to update its state. For example, each one of outputs 375dr and 375dk of module 352d may be used to do identity a change in biometric identity, consistency checker module 366dk itself may be a separate module as shown in FIG. 3, but it can also be integrated into A&E module 380. Additionally or alternatively, output 375dr may be configured to provide additional statistical information about the nature of the identity that could potentially help A&E module 380 to make a better and more accurate prediction. Without module 352d, A&E module 380 may not be able to detect identity change.

### Quality Evaluation

As shown in FIG. 3, quality checks detector module 352e of detector 350 may include (i) any suitable current frame (e.g., frame n) image data preprocessing module 364e that may be configured to receive any suitable image data 325e (e.g., from any suitable current frame 325f) and process such image data 325e to generate any suitable current frame processed image data 325e′ and any suitable current frame processed image data 325e″, (ii) any suitable biometric presence detector module 366ed that may be configured to receive any such current frame processed image data 325e″ from module 364e and process such received current frame processed image data 325e″ to generate any suitable biometric processed image data 325e′″, and (iii) any suitable quality evaluation module 366eq that may be configured to receive any current frame processed image data 325e′ from module 364e and/or any biometric processed image data 325e′″ from module 366ed and process such received processed image data to generate any suitable quality checks detector output data 375e for A&E module 380. Module 366eq may be configured to include a collection of classifiers that may be configured to decide about content quality (e.g., by looking at an image and determining what is wrong with it (e.g., quality of image generally (e.g., too blurry) and/or quality of biometric data (e.g., eyes occluded) and/or the like (e.g., rather than detecting spoofs, as done by module 352c))). This may be used to at least help determine whether or not one or some or all other modules of the detector is using worthwhile data. In some embodiments, only module 352e may be initially run and only if its output (e.g., output 375e) indicates a satisfactory quality or some particular quality may the detector run one or more other modules (e.g., one or more of modules 352a-352d). However, in other embodiments, all of modules 352a-352e may be run in parallel and A&E module 380 may be configured to determine whether or not to disregard all other data about a frame or package that may have been determined at least partially by module 352e to be insufficient (e.g., too blurry, etc.). Module 366eq may include at least one classifier model that may output a fixed amount of classes (e.g., outputs the class or probability of each class (e.g., a ski mask classifier, occlusion classifier (e.g., any of ski mask, sunglasses, reading glasses, face mask, respirator, no occlusion or independent classifiers for each))). Quality checks detector module 352e (e.g., module 366eq) may be configured to estimate the quality of a frame (e.g., using data 325e′ and/or data 325e′″) and provide this estimated frame quality information to the multi-frame aggregator (e.g., as data 375e to A&E module 380). Data 325e′″ may be indicative of a location of any biometric material in the current image data frame and then module 366eq may receive this biometric material location data 325e′″ (e.g., indicative of existence if any and location of different biometric info (e.g., face(s), fingerprint(s), etc.)) and raw/processed image data 325e/325e′ for the frame data. Classes of module 366eq (e.g., classifier outputs of a classifier model of module 366eq) may be indicative of what kind of errors/quality aspects may not be sufficient in the image (e.g., no face, portion of face out of frame, multiple faces, face occlusion (e.g., different types of occlusion (e.g., mask, sunglasses, reading glasses (e.g., a policy may be defined that may usually allow reading glasses for authentication but not enrollment, while different policy makers can vary on this), etc.)), eyes closed (e.g., sleeping (e.g., policies may be defined that can dictate what % of a session's frames may include eyes closed)), poor illumination (e.g., overall image), blur (e.g., motion blur, normal blur (e.g., overall image)), illumination for biometric entity specifically, blur for biometric entity specifically, face too big, face too small, face not centered, and/or the like). In some embodiments, any suitable policy may be applied on top of one or more classifiers. Additionally or alternatively, the system may be configured to make a decision about a presentation attack detection or spoof (e.g., a machine learning scenario where the system may determine how to weight different classifiers (e.g., in low light, certain classifiers weighted higher than others, etc.), where the system can use an ensemble through time for a particular module and/or for all modules per package or over multiple packages, which may be done manually by expert knowledge or automatically based on the data). The output of quality checks detector module 352e to A&E module 380 (e.g., data 375e) may be any suitable format, such as a vector of real and integer values (e.g., a list of probabilities, such as real numbers of these classifiers). For example, each real value may indicate a probability or an estimate (e.g., examples of real values may include, but are not limited to, the estimated amount of blur in the frame, the probability that an image in the frame is underexposed, and/or the like), while each integer value may indicate a class index (e.g., examples of classes may include, but are not limited to, one sample/multiple samples, blur/no blur, high/low sensor quality, and/or the like). Additionally or alternatively, quality checks detector module 352e may be configured to inform users about issues with a supplied image or other suitable biometric frame (e.g., as user feedback information 350iq). Quality checks detector module 352e may include one or more detectors (e.g., one or more biometric presence detector modules 366ed). Each detector may be configured for implementing software image detection but may additionally or alternatively work with hardware (e.g., a fingerprint sensor may send a fingerprint image and its own hardware information about a probability of a finger being present (e.g., such metadata may be a part of image data 325 rather than sensor data 345 (e.g., a very hardware-specific implementation, but may also or alternatively be considered fast data))). Each detector may be configured to analyze one or various aspects of the captured biometric data, including, but not limited to, exposure (e.g., a detector may be configured to check for low exposure levels or unusual lighting conditions that may indicate a presentation attack), blurriness (e.g., a detector may be configured to analyze the sharpness and clarity of an image to detect potential blurring or distortion that may be caused by a presentation attack), no biometric samples/multiple biometric samples present in a single frame (e.g., a detector may be configured to detect no face, or two or more faces in the same frame), sensor quality (e.g., a detector may be configured to evaluate the cleanliness and condition of a camera sensor to detect any issues that may affect the accuracy of the biometric data), and/or the like.

The detectors of module 366ed can be combined and weighted to provide users with feedback on the quality of their supplied images (e.g., using any suitable quality evaluation technique(s) and any suitable UIs via any suitable aggregator/evaluator (e.g., quality evaluation module 366eq may be configured to analyze any suitable output data 325e′″ from the one or more biometric presence detector(s) 366ed and/or any suitable output data 325e′ from any suitable image preprocessing module(s) 364e to generate any suitable output data 375e, which may be processed by A&E module 380 to generate any suitable user feedback information 350iq for presentation to any suitable user via any suitable UI(s) on any suitable device (e.g., managed element 399))). This information can help users to adjust (e.g., manually) their capture settings (e.g., of any suitable sensor(s) 315 and/or sensor(s) 315′) and/or to take corrective action to improve the accuracy of how their biometric data may be collected, and/or such information may be used automatically by system 301 to make such adjustments and/or to take such corrective action (e.g., the information may be configured to automatically adjust managed element 399 (e.g., to automatically adjust any suitable characteristic(s) of any suitable sensor(s) 315/315′ (e.g., to change an exposure length or refresh rate of a camera, to turn on/off or adjust brightness of a flash light, and/or the like).

### Policies

As shown in FIG. 3, policies module 352f of detector 350 may include any suitable presentation attacks policy module 366f that may be configured to receive or otherwise access any suitable policy data 365f (e.g., configuration data (e.g., time out policies (e.g., how long to let detector process run before rejecting a session)), etc.) from any suitable data source(s) 360 and process such accessed policy data to generate any suitable policies module output data 375f for A&E module 380. The policies of the data source may be defined in any suitable manner by any suitable definer, such as by any suitable integrator or administrator of the APSP. Policies module 352f may be configured to determine a presentation attack result (e.g., by generating any suitable policy output data 375f) based on any suitable policy rules (e.g., as may be defined by module 366f and/or as may be dictated by any suitable policy data 365f). These rules can be predefined (e.g., by module 366f) and/or learned from data (e.g., from data 365f). These rules may be configured to take into account one or more factors of any suitable factor type(s), including, but not limited to, timeouts (e.g., if the system fails to provide a decision within a specified amount of time and/or number of frames, the system may be configured not to flag the session as genuine but rather as indeterminate), biometric sample not present (e.g., if the presented sample does not contain the appropriate biometric information (e.g., face not present in picture, finger not present on sensor, etc.), the system may be configured to flag the session or the sample as a potential presentation attack (e.g., spoof) or decide to wait for additional samples (e.g., indeterminate)), sample quality is consistently too low for extended duration, sample quality too low (e.g., at least 10 images or >50% of the images cannot be too blurry, reject if less than 5 good images received in 3 seconds, etc.), face must be visible at all times, multiple faces policy (e.g., whether or not multiple faces are allowed in an image (e.g., sometimes passports have a big photograph and a water mark photograph, which may be detected and determined to be a passport being used as a spoof)), and/or the like

These policy rules can be combined and weighted to determine the final presentation attack result. Combination and weights may be predefined or learned from data. In the former case, each policy may have a weight associated with it, and the aggregator may combine the result of a particular policy with the weight to update its state. In the case where the policies are learned from data, the learning process may be performed offline during a training phase, where for instance the aggregator is presented with a series of labeled authentication sessions (labels may include “genuine” and “spoof”). Based on these sessions, the aggregator may be trained to predict the label. In some embodiments, A&E module 380 may be configured to aggregate the inputs that come from the various different modules 352a-352e of detector 350 in a stochastic way (e.g., as neural network inputs to one or more models of module 380), while output 375f of module 352f may be configured not to contribute to any input(s) of any suitable model(s) of module 380, but instead output 375f of module 352f may rather directly overrule any decision(s) that may be made by module 380. This may allow any suitable entity (e.g., an administrator, integrator, etc.) to have a high degree of control over certain situations (e.g., in case of a detected low quality of a session (e.g., the detector cannot a face for a certain amount of time) or in case of detection of some clear give away indications that a spoofing attempt is in process).

### Multi-frame Aggregator and Policy Evaluator

As shown in FIG. 3, A&E module 380 of detector 350 may be configured to process any such output data 375 from any such module(s) 352 (e.g., over an unbounded number N of frames 325f of frame or image data 325 (e.g., data that may be provided by a module 320 that may be the same as or similar to module 220 of system 201 of FIG. 2 and/or data that may be provided by any suitable sensor(s) 315 that may be the same as or similar to sensor(s) 215 of system 201 of FIG. 2 and/or data that may be the same as or similar to data 225 of system 201 of FIG. 2) and/or any suitable motion data 345 (e.g., data that may be provided by a module 340 that may be the same as or similar to module 240 of system 201 of FIG. 2 and/or data that may be provided by any suitable sensor(s) 315′ that may be the same as or similar to sensor(s) 215′ of system 201 of FIG. 2 and/or data that may be the same as or similar to data 245 of system 201 of FIG. 2)) and to generate, based on such processing, (i) any suitable user feedback information 350iq (e.g., user feedback information that may be the same as or similar to user feedback information 250iq of FIG. 2) and/or (ii) one or more computed decisions (e.g., as computed decision data 385) that may be used to generate any suitable presentation attack result information 350ir (e.g., presentation attack result information that may be the same as or similar to presentation attack result information 250ir of FIG. 2), where such generated detector information 350i (e.g., any suitable user feedback information 350iq and/or any suitable presentation attack result information 350ir) may be provided to any suitable managed element(s) 399 that may be configured to utilize such generated detector information 350i to control any suitable functionality(ies) of element 399. &E module 380 may be at least partially implemented using any suitable variety of machine learning techniques, including, but not limited to, deep neural networks (e.g., long short-term memory (“LSTM”) or any other suitable type of a recurrent neural network (“RNN”), and/or transformers). Such a hybrid approach may use the strengths of individual detector modules, each of which may be configured to identify specific types of presentation attacks, and each of which may apply various policies to determine the authenticity of the presented biometric information. Further, this approach can combine multiple detectors or models that may be configured to output a decision based on a fixed value (e.g., one, two, three, or more) and/or detectors or models that may be configured to output a decision based on an unbounded number of frames, into a system that may be configured to output a decision based on an unbounded number of frames. A&E module 380 may be configured to serve as a central hub where output from various other components (e.g., (a) data 375 a from sensor data mechanism module 352a, (b) data 375be and/or data 375bc from depth and motion detection mechanism module 352b, (c) data 375c from screen and PAI detection mechanism module 352c, (d) data 375dr and/or data 375dk from identity consistency detection mechanism module 352d, (e) data 375e from quality checks mechanism module 352e and/or (f) data 375f from policies module 352f) may be routed and aggregated. A&E module 380 may be configured to collect and process information from any suitable combination of such multiple sources, possibly including sensor data processing, depth estimation, screen and instrument detection, identity consistency detection, and quality check detection, across some or all frames supplied during the session. Further, A&E module 380 may be configured to process policies defined in a policy module. In some embodiments, A&E module 380 may include one or more classifier models, where classifiers of such model(s) may include any suitable classifiers, including, but not limited to, user feedback (e.g., image too dark, partial face, face too big, face too small, face not centered (e.g., these three could be combined as just face not in proper position)), spoof, genuine, indeterminate (e.g., we need more info (e.g., could need better info or could need more info/more frames before a decision can be made (e.g., determined as genuine but not going to finish because more images may be needed to make a biometric template for authentication))), rejected not spoof (e.g., must stop session (e.g., all images blurry, which will take up too much memory, time out (e.g., too many indeterminates in a row), taking too long (e.g., face not determinable, don't want to flag as spoof but just too difficult to handle this session so preferable to stop (e.g., low light scenario)))).

After each new frame or each new package has been received, A&E module 380 may be configured to produce a decision regarding the authenticity of the presented biometric data of the current session up to that new frame. Therefore, detector 350 may be configured to run an instance of its presentation attack detection process for each new package 335 received by the detector (e.g., each iteration of use of a presentation attack detector may process a new set of input(s) (e.g., a new data package from a data packaging module)), such that detector 350 may be configured to make a presentation attack decision each time a new package is received. The decision may be indicative of one of various possible outcomes, including, but not limited to, “indeterminate”, “spoof”, or “genuine”, “rejection”, and/or indicative of any suitable user feedback (e.g., as may be presented to a user for promoting one or more user responses and/or as may be automatically processed by the system for automatically carrying out one or more system responses). The decision may be determined based on any number of the frames that have been processed in the active authentication session. Specifically, the number of frames may be unbounded (e.g., the number of frames used (e.g., processed and considered) to output a decision may be the same as the number of frames in the session, which may be unbounded), or fixed (e.g., the aggregator may output a decision based on a fixed number of frames, or just the last frame). Depending on the situation, the system may be configured to bound the frames to be processed for certain modules (e.g., in order to detect the movement, the system may only evaluate frames that have a certain temporal distance between each other), as having bound frames may affect the accuracy of the system as well as its time to decision).

If the outcome is “indeterminate”, the system may be configured to indicate that additional frames may be required to make a determination and prompt the user to supply another frame to resolve the ambiguity. If the outcome is “spoof”, the entire session may be aborted, and any previously captured frames may be deemed invalid for recognition purposes, suggesting a deliberate attempt to deceive or manipulate the biometric data. Conversely, if the outcome is “genuine”, the system may be configured to determine that all frames from the session are authentic and can be used to extract biometric information for recognition purposes (e.g., all the frames in the session may be passed on to any suitable system (e.g., managed element 399) for processing for biometric recognition and/or authentication purposes).

Any suitable number and/or type(s) of policies (e.g., as may be defined by module 366f and/or defined by data 365f) may be used by A&E module 380. For example, policies module 352f may be configured to detect the triggering of the policies that may overrule a decision by A&E module 380 decision and to update its state and output a decision. For example, polices module 352f may not provide output 375f as an input to any model(s) of A&E module 380, but instead output 375f may be configured to control when an internal state of A&E subsystem 380 may be updated (e.g. when a face is not detected, policies module 352f may be configured to force A&E module 380 to not update its state and may overrule A&E module 380 decision(s) (e.g. making the system SPOOF and disregard a genuine verdict by A&E module 380)). Additionally or alternatively, specific output(s) from one or more modules (e.g., output data 375a, 375bc, 375be, 375c, 375dk, 375dr, 375dk, and/or 375e of module(s) 352a, 352b, 352c, 352d, 352e, and/or 352f) may indicate to A&E module 380 that A&E module 380 may ignore its current state and immediately output a decision. In other words, a policy may define that a specific result from a module must lead to an immediate “spoof” decision. For example, if identity consistency detection module 352d detects two different identities in two different frames, A&E module 380 may receive data 375dr and/or data 375dk that may instruct A&E module 380 to ignore its current state or determination and output “spoof” (e.g., data 385 that may direct module 390 to output a result 350irs). A&E module 380 may be configured to keep an internal state based on the input(s) it has processed up to that point. In some embodiments, an indeterminate result 350iri may be determined (e.g., if takes too much time to make a decision (e.g., based on the number of packages processed)). In some embodiments, output 385 of A&E module 380 may be provided as a real number over a range, such as 0-100, such as ranging from spoof to genuine, and policy data 375 f may be configured to dictate (e.g., at module 390) various thresholds for what values of output 385 result in what respective results 350ir (e.g., module 390 may be configured to take into account policies output 375f and/or quality checks output 375e when determining how to use A&E module output 385 to generate a specific one of results 350irs, 350irg, 350iri, 350irr, or the like (e.g., different customers may tweak how probability of spoof may be used (e.g., for enrollment vs. authorization) and/or to override or specially curate a probability of spoof)). In some embodiments, policies output 375f may have multiple implementations (e.g., if output 385 is a 100 score, but the system knows image quality is poor, policy can have decision be rejected to increase security (e.g., almost a way of safeguarding against machine learning hallucinations, etc.)).

A&E module 380 can be implemented using any suitable approach, including, but not limited to, a fixed rules-based system, machine learning algorithm(s), and/or ensembles of machine learning models. These approaches may provide different tradeoffs between efficiency, adaptability, and accuracy, and can be used separately or in combination to optimize the detection of presentation attacks. In some embodiments, rule-based systems may offer a high degree of control and predictability but may not be as robust and/or may lack the adaptability of machine learning systems. In some embodiments, module 380 may be configured to provide output 385 as a real number in any suitable range (e.g., between 0 and 100) indicative of a confidence level of an attack, while module 390 may be configured to process that number in any suitable manner for generating an appropriate result 350ir (e.g., module 390 may be configured to utilize a multiple threshold system (e.g., if output 385 is greater than 80 then return spoof result 350irs, if output 385 is less than 15 then return genuine result 350irg, if output 385 is 15-80 then return indeterminate result 350iri, etc.)). Module 390 may be enabled to override any such result and/or adjust such threshold(s) based on any suitable data (e.g., policy data 375f, quality checks output 375e, and/or the like). In some embodiments, the entirety of detector 350 may be provided as a single large neural network or model (e.g., mesh model) or as any suitable number of distinct models. The distinct modules and models described herein may be considered in some embodiments as more informative and/or exemplary for defining particular functions. Each model of the detector may be configured to determine how to propagate information regardless of how many models may be used, and it may be useful to train the model(s) on as much training data as possible with as much variation as possible. Data 345 (e.g., as training data and/or as detector input data during an active session) may include any suitable data that may be made available from a device that may be used during a session, including, but not limited to, location data, temperature/weather data, air quality data, light quality data, sound data, altitude data, wireless communication component data, movement data, image data, and/or the like. Detector 250 may be configured to run an instance of its presentation attack detection process for each new package 235 received by the detector.

Any suitable presentation attack detecting system model (e.g., any model or module of detector 350) may be developed and/or generated for use in evaluating and/or predicting output states (e.g., a likelihood of an attack). For example, a model may be a learning engine for an experiencing entity, where the learning engine may be operative to use any suitable machine learning (“ML”) (e.g., the system's ability to learn automatically from past events to affect future behavior) to use certain monitored system data for a particular environment in order to predict, estimate, and/or otherwise generate an output state (e.g., a likelihood of an attack (e.g., data 375ac, data 375bc, data 375c, data 375e, data 385, and/or the like)). For example, the learning engine may include any suitable neural network (e.g., an artificial neural network) that may be initially configured, trained on one or more sets of monitored system data (e.g., any suitable data 325/335/345) associated with known or otherwise determined or confirmed states or data from any suitable sources (e.g., truthful presentation attack information for the monitored system data, which is also used during the training), and then used to predict further states or determine the likelihood of further states based on another set of monitored system data.

A neural network or neuronal network or artificial neural network may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

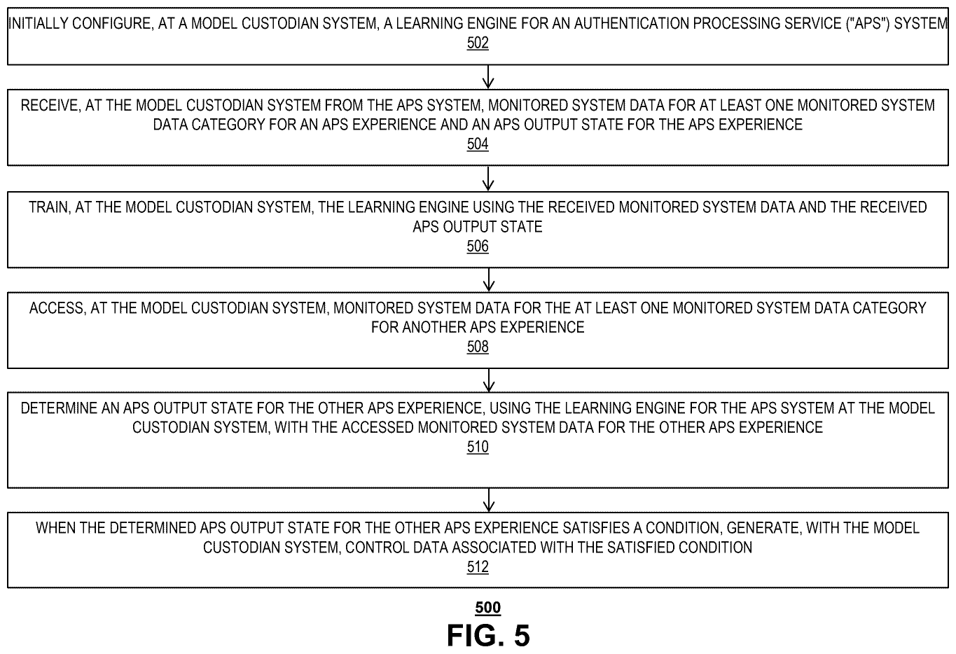

Different input neurons of the neural network may be associated with respective different types of monitored system data categories and may be activated by monitored system data of the respective monitored system data categories (e.g., each possible category of monitored system data variable information (e.g., image data from each possible sensor 315 (e.g., image data frames), motion/environment data from each possible sensor 315′ (e.g., ALS data, gyroscope data, magnetometer data, IMU data, accelerometer data, microphone data, wireless communication data, weather data, location data, etc.), information indicative of the make/model and current settings of each data providing sensor 315/315′, etc.) may be associated with one or more particular respective input neurons of the neural network and monitored system data for the particular monitored system data category may be operative to activate the associated input neuron(s)). The weight assigned to the output of each neuron may be initially configured (e.g., at operation 502 of process 500 of FIG. 5) using any suitable determinations that may be made by a custodian or processor of the model (e.g., subsystem 10, device 60, node(s) 70, subsystem 90, etc.) based on the data available to that custodian.

The initial configuring of the learning engine or management model for a particular system (e.g., the initial weighting and arranging of neurons of a neural network of the learning engine) may be done using any suitable data accessible to a custodian of the management model (e.g., an administrator or integrator of the detector), such as data associated with the configuration of other learning engines of the system (e.g., learning engines or management models for other systems), data associated with the particular system (e.g., initial background data accessible by the model custodian about the particular system composition, location, past uses, and/or the like), data assumed or inferred by the model custodian using any suitable guidance, and/or the like. For example, a model custodian may be operative to capture any suitable initial background data about a particular system in any suitable manner, which may be enabled by any suitable user interface provided to an appropriate subsystem or device accessible to one, some, or each operator or entity with knowledge of the particular system (e.g., a model app or website). The model custodian may provide a data collection portal for enabling any suitable entity to provide initial background data for the particular system. The data may be uploaded in bulk or manually entered in any suitable manner.

A management model custodian may receive (e.g., at operation 504 of process 500 of FIG. 5) not only monitored system data for at least one monitored system data category for a particular APS experience (e.g., particular data sensors receiving particular slow/fast data during a particular authentication session) but also an APS output state for that APS experience (e.g., truthful presentation attack information for the monitored system data (e.g., printed picture attack, mask attack, etc.)). This may be enabled by monitoring any suitable system data for an APS system. The management model custodian may provide a data collection portal for enabling any suitable entity(ies) to provide such data. The system output state may be received and may be derived from the system in any suitable manner.

A learning engine or model for an APS system may be trained (e.g., at operation 506 of process 500 of FIG. 5) using the received monitored system data for the APS experience (e.g., as inputs of a neural network of the learning engine) and using the received APS output state for the APS experience (e.g., as an output of the neural network of the learning engine). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving monitored system data and an APS output state for an APS experience (e.g., particular data sensors receiving particular slow/fast data during a particular authentication session) and then training the system model using the received monitored system data and APS output state may be repeated any suitable number of times for the same system(s) in different APS experiences (e.g., in same or different environments at different moments) and the same learning engine for more effectively training the learning engine for the system, where the received monitored system data and the received APS output state of different receipt and train loops may be for different environments or for the same environment (e.g., at different times and/or with respect to different presentation attacks or no attack and/or with different users) and/or may be received from the same source or from different sources of the system, while the training of different receipt and train loops may be done for the same learning engine using whatever monitored system data and APS output state was received for the particular receipt and train loop. The number and/or type(s) of the one or more monitored system data categories for which monitored system data may be received for one receipt and train loop may be the same or different in any way(s) than the number and/or type(s) of the one or more monitored system data categories for which monitored system data may be received for a second receipt and train loop.

A trained model may then receive input data from any suitable source using any suitable methods for use by the model. The trained model may then use this new input data to generate output data using the learning engine or model. For example, the new input data may be utilized as input(s) to the neural network of the learning engine similarly to how other input data accessed for a receipt and train loop may be utilized as input(s) to the neural network of the learning engine at a training portion of the receipt and train loop, and such utilization of the learning engine with respect to the new input data may result in the neural network providing an output indicative of data that may represent the learning engine's predicted or estimated result.

The processing power and speed of any suitable APS or presentation attack detecting system and its various models may be configured to determine continuously an updated APS output state of a system and present associated information or otherwise adjust a managed element based on the determined APS output state automatically and instantaneously or substantially instantaneously based on any new received monitored system data that may be generated by the system, such that management of the system may run quickly and smoothly. This may enable the system to operate as effectively and as efficiently as possible.

A model custodian may access (e.g., at operation 508 of process 500 of FIG. 5) monitored system data for at least one monitored system data category for another APS experience (e.g., an APS experience that is different than any APS experience considered at any monitored system data receipt and train loop for training the learning engine). In some embodiments, this other APS experience may be an APS experience that has not been specifically experienced by any system prior to use of the model in an end user use case (e.g., at operation 508). Although, it is to be understood that this other APS experience may be any suitable APS experience (e.g., any suitable set of circumstances for an APS system and its environment). The monitored system data for this other APS experience may be accessed from or otherwise provided by any suitable source(s) using any suitable methods for use by the model custodian.

This other APS experience (e.g., APS experience of interest) may then be processed to have its APS output state be determined (e.g., at operation 510 of process 500 of FIG. 5) using the learning engine or model for the APS system with the monitored system data accessed for such another APS experience. For example, the monitored system data accessed for the APS experience of interest may be utilized as input(s) to the neural network of the learning engine (e.g., at operation 510 of process 500 of FIG. 5) similarly to how the monitored system data accessed at a receipt portion of a receipt and train loop may be utilized as input(s) to the neural network of the learning engine at a training portion of the receipt and train loop, and such utilization of the learning engine with respect to the monitored system data accessed for the APS experience of interest may result in the neural network providing an output indicative of an APS output state that may represent the learning engine's predicted or estimated APS output state to be derived from the APS system in the APS experience of interest.

After an APS output state (e.g., a likelihood of an attack (e.g., data 375ac, data 375bc, data 375c, data 375e, data 385, and/or the like)) is realized for an APS experience of interest (e.g., for a current authentication session being experienced by an APS system), it may be determined (e.g., at operation 512 of process 500 of FIG. 5) whether the realized APS output state satisfies a particular condition of any suitable number of potential conditions and, if so, the model custodian or any other suitable processor assembly or otherwise may generate any suitable control data (e.g., data 350i) that may be associated with that satisfied condition for controlling any suitable functionality of any suitable output assembly of the APS system or otherwise (e.g., for controlling any suitable managed element 399).

Therefore, any suitable model custodian may be operative to generate and/or manage any suitable model or learning engine that may utilize any suitable machine learning, such as one or more artificial neural networks, to analyze certain monitored system data of an APS system to predict/estimate a likelihood of a presentation attack during an authentication session, which may enable intelligent suggestions to be provided to an operator and/or intelligent system functionality adjustments to be made for improving the operator's experiences and the system's productivity.

The use of one or more suitable models or engines or neural networks or the like may enable prediction or any suitable determination of a likelihood of an APS output state of a system in an APS experience (e.g., likelihood of a presentation attack in that experience). Such models (e.g., neural networks) running on any suitable processing units (e.g., graphical processing units (“GPUs”) that may be available to the system) provide significant speed improvements in efficiency and accuracy with respect to prediction over other types of algorithms and human-conducted analysis of data, as such models can provide estimates in a few milliseconds or less, thereby improving the functionality of any computing device on which they may be run.

Due to such efficiency and accuracy, such models enable a technical solution for enabling the generation of any suitable control data (e.g., for controlling any suitable functionality of any suitable managed element) using any suitable real-time data (e.g., data made available to the models) that may not be possible without the use of such models, as such models may increase performance of their computing device(s) by requiring less memory, providing faster response times, and/or increased accuracy and/or reliability. Due to the condensed time frame and/or the time within which a decision with respect to system data ought to be made to provide a desirable use experience, such models offer the unique ability to provide accurate determinations with the speed necessary to enable effective and efficient use management.

### FIG. 5

FIG. 5 is a flowchart of an illustrative process 500 for managing an APS system. At operation 502 of process 500, a model custodian (e.g., a model custodian system) may initially configure a learning engine (e.g., any model or module of detector 350) for an APS system. At operation 504 of process 500, the model custodian may receive, from the APS system, monitored system data for at least one monitored system data category for an APS experience and an APS output state for the APS experience. At operation 506 of process 500, the model custodian may train the learning engine using the received monitored system data and the received APS output state. At operation 508 of process 500, the model custodian may access monitored system data for the at least one monitored system data category for another APS experience. At operation 510 of process 500, the model custodian may determine an APS output state, using the learning engine, with the accessed monitored system data for the other APS experience. At operation 512 of process 500, when the determined APS output state for the other APS experience satisfies a condition, the model custodian may generate control data associated with the satisfied condition (e.g., when the determined APS output state for the other APS experience satisfies a condition, the model custodian may control any suitable managed element in any suitable manner based on the satisfied condition).

It is understood that the operations shown in process 500 of FIG. 5 are only illustrative and that existing operations may be modified or omitted, additional operations may be added, and the order of certain operations may be altered.

### Additional Disclosure

One, some, or all of the processes described with respect to FIGS. 1-5 and otherwise may each be partially or entirely implemented by software, but may also be implemented in hardware, firmware, or any combination of software, hardware, and firmware. Instructions for performing these processes may also be embodied as machine-or computer-readable code recorded on a machine-or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1A). In other embodiments, the computer-readable medium may be a transitory computer-readable medium.

In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure (e.g., any or each module of system 101) may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types.

The number, configuration, functionality, and interconnection of the modules and components and subsystems of system 101 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure (e.g., system 101) may be stored in or otherwise accessible to a subsystem (e.g., subsystem 120) in any suitable manner (e.g., in memory 13 (e.g., as at least a portion of application 19a and/or model 19m)). Any or each module of any suitable system of the disclosure (e.g., system 101) may be implemented using any suitable technologies (e.g., as one or more integrated circuit devices), and different modules may or may not be identical in structure, capabilities, and operation. Any or all of the modules or other components of any suitable system of the disclosure (e.g., system 101) may be mounted on an expansion card, mounted directly on a system motherboard, or integrated into a system chipset component (e.g., into a “north bridge” chip). At least a portion of one or more of the modules of any suitable system of the disclosure (e.g., system 101) may be stored in or otherwise accessible to any suitable components in any suitable manner. Any or each module of any suitable system of the disclosure (e.g., system 101) may be implemented using any suitable technologies (e.g., as one or more integrated circuit devices), and different modules may or may not be identical in structure, capabilities, and operation. Any or all of the modules or other components of any suitable system of the disclosure (e.g., system 101) may be mounted on an expansion card, mounted directly on a system motherboard, or integrated into a system chipset component (e.g., into a “north bridge” chip).

Any or each module of any suitable system of the disclosure (e.g., system 101, system 201, system 301, etc.) may be a dedicated system implemented using one or more expansion cards adapted for various bus standards. For example, all of the modules may be mounted on different interconnected expansion cards or all of the modules may be mounted on one expansion card. With respect to system 101, by way of example only, modules of system 101 may interface with a motherboard or processor assembly 12 (e.g., of subsystem 120) through an expansion slot (e.g., a peripheral component interconnect (“PCI”) slot or a PCI express slot). Alternatively, modules of system 101 need not be removable but may include one or more dedicated modules that may include memory (e.g., RAM) dedicated to the utilization of the module. In other embodiments, modules of system 101 may be at least partially integrated into a subsystem (e.g., subsystem 120 (e.g., a server)). For example, a module of system 101 may utilize a portion of memory 13 of a subsystem. Any or each module of system 101 may include its own processing circuitry and/or memory. Alternatively, any or each module of system 101 may share processing circuitry and/or memory with any other module of system 101 and/or processor assembly 12 and/or memory assembly 13 of a subsystem (e.g., subsystem 120).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

To facilitate the discussion regarding the operation of one or more systems of the disclosure, reference is made to various screens 400a-400i that may be representative of a graphical user interface of any suitable device 60 during any suitable process(es) of the system (e.g., as shown in FIGS. 4A-4I). The operations described may be achieved with a wide variety of graphical elements and visual schemes. Therefore, the embodiments of FIGS. 4A-4I are not intended to be limited to the precise user interface conventions adopted herein. Rather, embodiments may include a wide variety of user interface styles. In some other embodiments, in addition to or as an alternative to graphical and/or visual schemes, any suitable audible and/or haptic user interface conventions may be utilized.

As may be used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources.

These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations.

Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

One aspect of the present technology may be the gathering and use of data available from various sources to improve the detection of a user. The present disclosure contemplates that in some instances, this gathered data may include personal information data that uniquely identifies or can be used to contact or locate a specific person. Such personal information data can include demographic data, location-based data, telephone numbers, email addresses, social network identifiers, home addresses, office addresses, data or records relating to a user's health or level of fitness (e.g., vital signs measurements, facial expression measurements, medication information, exercise information, etc.) and/or mindfulness, date of birth, or any other identifying or personal information.

The present disclosure recognizes that the use of such personal information data, in the present technology, can be used to the benefit of users. For example, the personal information data can be used to improve the determination of detecting presentation attack. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location detection services, the present technology can be configured to allow users to select to “opt in” or “opt out” of participation in the collection of personal information data during registration for services or anytime thereafter. In addition to providing “opt in” or “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the determination of detecting liveness or presentation attack can be made based on non-personal information data or a bare minimum amount of personal information, such as the content being requested by the device associated with a user, other non-personal information available to the device, or publicly available information.

While there have been described systems, methods, and computer-readable media for detecting presentation attack, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims.

Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

1. A method for managing an authentication processing service (“APS”) system using a model custodian system, the method comprising:
initially configuring, at the model custodian system, a learning engine for the APS system;
receiving, at the model custodian system from the APS system, monitored system data for at least one monitored system data category for a first APS experience and an APS output state for the first APS experience;
training, at the model custodian system, the learning engine using the received monitored system data and the received APS output state;
accessing, at the model custodian system, monitored system data for the at least one monitored system data category for a second APS experience;
the second APS experience is a biometric authentication session;
determining, using the learning engine at the model custodian system and based on the accessed monitored system data for the second APS experience, an APS output state for the second APS experience that is insufficient to determine whether a presentation attack is occurring during the biometric authentication session;
generating, at the model custodian system, control data associated with the APS output state, the control data being operative to adjust a control variable at the APS system to obtain additional biometric data from a user during the second APS experience;
accessing, at the model custodian system, the additional biometric data obtained by the APS system from the user during the second APS experience; and
determining, using the learning engine at the model custodian system with the additional biometric data, a likelihood of a presentation attack during the second APS experience.

2. The method of claim 1, wherein the at least one monitored system data category comprises an image and motion sensor data.

3. The method of claim 1, wherein the at least one monitored system data category comprises an image and microphone sensor data.

4. The method of claim 1, wherein the at least one monitored system data category comprises an image and location data.

5. The method of claim 1, wherein the at least one monitored system data category comprises an image and sensor data captured over a period of time.

6. The method of claim 1, wherein the control data is operative to provide a recommendation to adjust the control variable at the APS system.

7. The method of claim 1, wherein the control data is operative to automatically adjust the control variable at the APS system.

8. The method of claim 1, wherein the control data is first control data, the method further comprising:
generating second control data operative to end the biometric authentication session in response to determining the likelihood of the presentation attack during the second APS experience.

9. The method of claim 1, wherein the control data is operative to automatically use the accessed monitored system data for the second APS experience to authenticate the biometric authentication session.

10. A model custodian system comprising:
a communications component; and
a processor operative to:
initially configure a learning engine for an authentication processing service (“APS”) system;
receive, from the APS system, monitored system data for at least one monitored system data category for a first APS experience and an APS output state for the first APS experience;
train the learning engine using the received monitored system data and the received APS output state;
access monitored system data for the at least one monitored system data category for a second APS experience, the second APS experience is a biometric authentication session;
determine, using the learning engine and based on the accessed monitored system data for the second APS experience, an APS output state for second APS experience that is insufficient to determine whether a presentation attack is occurring during the biometric authentication session; and
generate control data associated with the APS output state, the control data being operative to adjust a control variable at the APS system to obtain additional biometric data from a user during the second APS experience;
access the additional biometric data obtained by the APS system from the user during the second APS experience; and
determine, using the learning engine with the additional biometric data, a likelihood of a presentation attack during the second APS experience.

11. A non-transitory computer-readable storage medium storing at least one program, the at least one program comprising instructions, which, when executed by at least one processor of an electronic subsystem, cause the at least one processor to:
initially configure a learning engine for an authentication processing service (“APS”) system;
receive, from the APS system, monitored system data for at least one monitored system data category for a first APS experience and an APS output state for the first APS experience;
train the learning engine using the received monitored system data and the received APS output state;
access monitored system data for the at least one monitored system data category for a second APS experience, the second APS experience is a biometric authentication session;
determine, using the learning engine and based on the accessed monitored system data for the second APS experience, an APS output state for the second APS experience that is insufficient to determine whether a presentation attack is occurring during the biometric authentication session;
generate control data associated with the APS output state, the control data being operative to adjust a control variable at the APS system to obtain additional biometric data from a user during the second APS experience;
access the additional biometric data obtained by the APS system from the user during the second APS experience; and
determine, using the learning engine with the additional biometric data, a likelihood of a presentation attack during the second APS experience.

12. The method of claim 1, wherein the control data is operative to automatically adjust at least one of: an exposure length of a sensor of the APS system, a refresh rate of a sensor of the APS system, or a brightness of a light source of the APS system.

13. The method of claim 1, wherein the control data is operative to present an audible or visual prompt to the user to move to a brighter area during the second APS experience.

14. The method of claim 1, wherein the control data is operative to present a prompt to the user to adjust at least one of a head pose, a body position, or a distance from a sensor of the APS system during the second APS experience.

15. The method of claim 1, wherein the control data is operative to present a prompt to the user indicating that a single face should be present within a capture field of a sensor of the APS system during the second APS experience.

16. The method of claim 1, wherein the control data is operative to present visual quality indicator feedback via an output component of the APS system, the visual quality indicator feedback is updated as a quality of the additional biometric data obtained from the user during the second APS experience changes.

17. The model custodian system of claim 10, wherein the control data is operative to automatically adjust at least one of: an exposure length of a sensor of the APS system, a refresh rate of a sensor of the APS system, or a brightness of a light source of the APS system.

18. The model custodian system of claim 10, wherein the control data is operative to present visual quality indicator feedback via an output component of the APS system, the visual quality indicator feedback is updated as a quality of the additional biometric data obtained from the user during the second APS experience changes.

19. The non-transitory computer-readable storage medium of claim 11, wherein the control data is operative to automatically adjust at least one of: an exposure length of a sensor of the APS system, a refresh rate of a sensor of the APS system, or a brightness of a light source of the APS system.

20. The non-transitory computer-readable storage medium of claim 11, wherein the control data is operative to present visual quality indicator feedback via an output component of the APS system, the visual quality indicator feedback is updated as a quality of the additional biometric data obtained from the user during the second APS experience changes.
